(19) United States
(12) Patent Application Publication
(10) Pub. No.: US 2023/0210056 A1
(43) Pub. Date: Jul. 6, 2023

(54) Harvester and Threshing Apparatus

(71) Applicant: Kubota Corporation, Osaka-shi (JP)

(72) Inventor: Takafumi Mitsui, Sakai-shi (JP)

(21) Appl. No.: 17/927,843

(22) PCT Filed: Jul. 1, 2021
(86) PCT No.: PCT/JP2021/024910

§ 371 Date: Nov. 25, 2022

(30) Foreign Application Priority Data
Jul. 22, 2020 (JP) 2020-125588
Jul. 22, 2020 (JP) 2020-125589
Jul. 22, 2020 (JP) 2020-125590
Jul. 22, 2020 (JP) 2020-125591

(51) Int. Cl. A01F 12/28; A01F 7/06; A01F 12/56; A01F 12/54

(52) U.S. Cl. CPC A01F 12/28; A01F 7/06; A01F 12/56; A01F 12/54; A01F 12/22

(57) ABSTRACT

The threshing apparatus 6 includes a threshing chamber 11 into which the crops are introduced, a threshing drum 12 that is provided in the threshing chamber 11 so as to rotate with the threshing drum axial center in the front-rear direction of the threshing chamber 11 serving as the rotation center, and which threshes the crops introduced into the threshing chamber 11, and a receiving net 13 provided in the outer periphery of the lower part of the threshing drum 12. The receiving net 13 is divided into a plurality of divided receiving net bodies 13A in the front-rear direction, the plurality of divided receiving net bodies 13A are operated to adjust, for each of the plurality of divided receiving net bodies, the interval S in the radial direction of the threshing drum 12 between the divided receiving net body 13A and the threshing drum 12.

### CROSS-REFERENCE TO RELATED APPLICATIONS

This application is the United States national phase of International Application No. PCT/JP2021/024910 filed Jul. 1, 2021, and claims priority to Japanese Patent Application No. 2020-125588 filed Jul. 22, 2020, 2020-125589 filed Jul. 22, 2020, 2020-125590 filed Jul. 22, 2020, and 2020-125591 filed Jul. 22, 2020, the disclosures of which are hereby incorporated by reference in their entireties.

### BACKGROUND OF THE INVENTION

### Field of the Invention

The present invention relates to a harvester, and more specifically, a harvester including a harvesting section that harvests crops in a field, and a threshing apparatus into which the crops harvested by the harvesting section are introduced and which threshes the introduced crops, the threshing apparatus including a threshing chamber into which the crops are introduced, a threshing drum that is provided in the threshing chamber so as to rotate using a threshing drum axis extending in a front-rear direction of the threshing chamber as a rotation axis, and that threshes the crops introduced into the threshing chamber, and a receiving net provided in an outer periphery of a lower part of the threshing drum.

The present invention also relates to a threshing apparatus for threshing harvested crops.

### DESCRIPTION OF RELATED ART

### Related Art 1

As shown in Japanese Patent No. 3418078, Patent Document 1, there is a threshing apparatus including a threshing chamber, a threshing drum that is rotatably provided in the threshing chamber and threshes the crops in the threshing chamber, and a receiving net provided in an outer periphery of a lower part of the threshing drum, in which an interval between the receiving net and the threshing drum can be adjusted by changing an attachment position of the threshing drum.

### Related Art 2

A threshing apparatus is provided with a threshing drum that rotates about an axis extending in a front-rear direction inside a threshing chamber, and threshes crops introduced into the threshing chamber with the threshing drum. In addition, a plurality of debris transport valves that guide processing material, which rotates while being moved around by the threshing drum, toward the rear of the threshing chamber, are provided side by side at an interval in the axial direction on the inner surface of a top plate of the threshing chamber. Conventionally, a plurality of debris transport valves are supported in such a manner that the feed angle can be changed by swinging about a vertical axis, and the plurality of debris transport valves are integrally swung so that all of the debris transport valves are changed to the same feed angle (see Japanese Patent Application Laid-Open No. 2019-83803, Patent Document 2, for example).

### Related Art 3

The threshing apparatus includes a threshing drum rotatably provided inside a threshing chamber into which reaped grain culms are introduced, and includes a receiving net along an outer periphery of the threshing drum, below the threshing drum. In addition, a sorting apparatus is included, which is located below the receiving net, receives the threshing material that has leaked from the receiving net, and sorts the threshing material while swinging and transferring the threshing material. Conventionally, an upstream end of the receiving net located on an upstream side in a rotation direction of the threshing drum and a downstream end thereof located on a downstream side in the rotation direction of the threshing drum are both provided at higher positions than the rotation axis of the threshing drum (for example, see Japanese Patent Application Laid-Open No. 2013-146272, Patent Document 3).

### Patent Documents

Patent Document 1: Japanese Patent No. 3418078

Patent Document 2: Japanese Patent Application Laid-Open No. 2019-83803

Patent Document 3: Japanese Patent Application Laid-Open No. 2013-146272

### SUMMARY OF THE INVENTION

Problem 1

The problem corresponding to [Related Art 1] is as follows.

A harvester is desired in which the interval between the receiving net and the threshing drum can be adjusted such that threshing is performed without insufficient threshing or the like when crops with different properties are harvested, when the amount of crops introduced into the threshing chamber changes, or the like. However, when the conventional technique is adopted, the attachment position of the threshing drum is changed, and therefore the interval between the receiving net and the threshing drum changes almost uniformly over the entire receiving net. Also, a large operating force is required.

The present invention provides a harvester capable of adjusting the interval between a receiving net and a threshing drum with a light operating force and in such a manner that the interval between the receiving net and the threshing drum is changed in various ways in the front-rear direction of the threshing chamber.

Also, the present invention provides a harvester that can easily and inexpensively adjust the interval between the receiving net and the threshing drum in such a manner that the interval is changed in various ways in the peripheral direction of the threshing drum.

Problem 2

The problem corresponding to [Related Art 2] is as follows.

The above-mentioned conventional configuration is a configuration in which the feed angle can be adjusted according to differences in the type and property of the crop, but all of the debris transport valves are changed to the same angle. For this reason, after the feed angle is changed and set, the same feeding function acts on substantially the entire region in the front-rear direction of the threshing chamber. That is, in order to improve the shedding performance, it is preferable to make the feed angle gentler and perform threshing appropriately. However, in this case, there is a disadvantage in that if stalk waste (discharged straw) resulting from threshing is to be used as animal feed, the grain culms will be severely damaged, making it unsuitable for animal feed, or the like.

In view of this, it has been desired to be able to adjust the feeding condition of the processing material by the debris transport valves to an appropriate state in response to differences in working conditions.

Problem 3

The problem corresponding to [Related Art 3] is as follows.

In the above-described conventional configuration, the threshing drum and the receiving net face each other along the peripheral direction of the threshing drum, and therefore the threshing performance on the crops is improved. However, in this configuration, when the threshing material that has been threshed and leaks from the receiving net is sorted by the lower sorting apparatus, the amount (layer thickness) of the threshing material that falls on the sorting apparatus varies significantly in the left-right direction.

To add description, in the portion of the sorting apparatus located on the upstream side in the rotation direction of the threshing drum in the receiving net, a large amount of the threshing material leaks downward since it is the location where the threshing performed by the rotating threshing drum and the receiving net is started while the crop is moved around when there is room in the radial direction on the upper side of the threshing drum. Moreover, since the upstream end of the receiving net is in a substantially vertical orientation and is steeply inclined, the leakage area of the receiving net per unit width in the left-right direction increases, which also increases the amount of threshing material. In the vicinity of the central portion of the receiving net in the left-right direction, the inclination of the receiving net is gentle and the leakage area of the receiving net per unit width in the left-right direction in the sorting apparatus is small, and therefore the amount of threshing material is reduced.

On the sorting apparatus, the amount of threshing material varies significantly, such as the amount of threshing material being the largest at the upstream side of the receiving net in the rotation direction of the threshing drum, and the amount being small in other areas. In this manner, when the amount of threshing material on the sorting apparatus increases locally, when the grains, which are the target material from the threshing material, are leaked out and sorted, there is a risk that the grains will be discharged outward together with straw waste without being sufficiently leaked out and sorted. As a result, there is a disadvantage that the sorting accuracy of the sorting apparatus is lowered.

In view of this, it has been desired to improve the sorting accuracy when sorting the threshing material, without lowering the threshing capacity.

The solution corresponding to the problem of providing a harvester that can adjust the interval between the receiving net and the threshing drum with a light operating force and in such a manner that the interval is changed in various ways in the front-rear direction of the threshing chamber in [Problem 1] is as follows.

A harvester according to the present invention includes: a harvesting section configured to harvest a crop in a field; and a threshing apparatus into which the crop harvested by the harvesting section is introduced and which is configured to thresh the introduced crop, in which the threshing apparatus includes a threshing chamber into which the crop is introduced, a threshing drum that is provided in the threshing chamber in such a manner as to rotate with a threshing drum axis extending in a front-rear direction of the threshing chamber serving as a rotation center, and configured to thresh the crop introduced into the threshing chamber, and a receiving net provided in an outer periphery of a lower part of the threshing drum, the receiving net is divided into a plurality of divided receiving net bodies in the front-rear direction, and the plurality of divided receiving net bodies are operated to adjust, for each of the plurality of divided receiving net bodies, an interval in a radial direction of the threshing drum between the divided receiving net body and the threshing drum.

According to this configuration, the interval between the receiving net and the threshing drum (the interval in the radial direction of the threshing drum) in the plurality of divided receiving net bodies can be adjusted for each divided receiving net body, and therefore the interval between the receiving net and the threshing drum can be adjusted in such a manner as to change in various ways in the front-rear direction of the threshing chamber. Since the interval between the receiving net and the threshing drum is adjusted by operating the divided receiving net bodies, the interval can be adjusted with a light operating force.

In the present invention, it is preferable to include an interval adjusting mechanism that is separately joined to each of the plurality of divided receiving net bodies and configured to adjust the interval in the divided receiving net body.

According to this configuration, since the operation for adjusting the interval of each divided receiving net body is performed by the dedicated interval adjusting mechanism connected to the divided receiving net body, it is easy to adjust the interval for each divided receiving net body.

In the present invention, it is preferable that the divided receiving net body includes a support shaft provided extending in the front-rear direction on one end in a peripheral direction of the threshing drum of the divided receiving net body, and the divided receiving net body is supported in such a manner as to be swingable vertically with the support shaft serving as a swinging support point, and the interval adjusting mechanism is joined to another end in the peripheral direction of the threshing drum of the divided receiving net body, and adjusts the interval of the divided receiving net body by swinging the divided receiving net body vertically.

According to this configuration, the interval between the divided receiving net body and the threshing drum is adjusted by vertically swinging the divided receiving net body, and therefore the support structure for the divided receiving net body can be simplified compared to the case where the interval between the divided receiving net body is adjusted by sliding the divided receiving net body.

In the present invention, it is preferable that the plurality of divided receiving net bodies are a front divided receiving net body and a rear divided receiving net body obtained by dividing the receiving net into two in the front-rear direction, the interval adjusting mechanism configured to adjust the interval of the front divided receiving net body includes a first electric motor configured to operate the interval adjusting mechanism, the interval adjusting mechanism configured to adjust the interval of the rear divided receiving net body includes a second electric motor configured to operate the interval adjusting mechanism, the first electric motor is provided outside of a front wall of the threshing chamber, and the second electric motor is provided outside of a rear wall of the threshing chamber.

According to this configuration, although the first electric motor is adopted as the motive power source for adjusting the interval of the front divided receiving net body and the second electric motor is adopted as the motive power source for adjusting the interval of the rear divided receiving net body, since the first electric motor can be handled outside the front wall and the second electric motor can be handled outside the rear wall, the first electric motor and the second electric motor can be easily inspected and repaired.

In the present invention, it is preferable to include: an actuator configured to adjust the intervals of the plurality of divided receiving net bodies; and a link mechanism linking the actuator and the plurality of divided receiving net bodies, in which the link mechanism transmits motive power with different link ratios to the plurality of divided receiving net bodies in such a manner that adjustment allowances of the intervals of the plurality of divided receiving net bodies adjusted by the actuator are different for the plurality of divided receiving net bodies.

According to this configuration, the motive power of the actuator is transmitted to the plurality of divided receiving net bodies by the link mechanism to operate the plurality of divided receiving net bodies, thereby adjusting the interval between the divided receiving net body and the threshing drum in the plurality of divided receiving net bodies. However, since the link ratio of the motive power transmission to the divided receiving net body by the link mechanism is different depending on the divided receiving net body, the interval adjustment of the plurality of divided receiving net bodies can be performed by the shared actuator, and thus it is possible to make the adjustment allowances for the interval adjustment in the divided receiving net bodies different depending on the divided receiving net body while reducing the number of actuators to be provided.

The solution corresponding to [Problem 2] is as follows.

A characteristic configuration of a threshing apparatus according to the present invention includes: a threshing chamber; a threshing drum that is rotatably provided in the threshing chamber and configured to perform threshing of a crop introduced into a front part of the threshing chamber; a top plate covering an upper portion of the threshing chamber; and a plurality of debris transport valves that are supported on the top plate, arranged side by side along a rotation axis of the threshing drum, and configured to feed and guide a threshing material toward a rear part of the threshing chamber, in which the plurality of debris transport valves are attached with changeable feed angles, and the threshing apparatus further includes: a first angle adjusting mechanism capable of simultaneously changing feed angles of a plurality of front debris transport valves located frontward among the plurality of debris transport valves; and a second angle adjusting mechanism capable of simultaneously changing feed angles of a plurality of rear debris transport valves located rearward among the plurality of debris transport valves.

According to the present invention, the feed angles of the plurality of front debris transport valves are changed and adjusted by the first angle adjusting mechanism. On the other hand, the feed angles of the plurality of rear debris transport valves are changed and adjusted by the second angle adjusting mechanism. That is, the feed angles of the plurality of front debris transport valves and the plurality of rear debris transport valves can be changed separately, and can be set to different feed angles.

For example, a method of use is possible in which, in the region on the front side of the threshing chamber, the feed angle of the debris transport valves is relaxed so as not to reduce the shedding performance, and in the region on the rear side of the threshing chamber, the feed angle of the debris transport valves is steepened to increase the transfer speed of the processing material and prevent the discharged straw from being damaged.

In the threshing chamber, the drive load of the threshing drum is large at the front side where the crops are first introduced, and the drive load is small at the rear side. In view of this, if the crops shed easily, a method of use is also possible in which, in the region on the front side of the threshing chamber, the feed angle of the debris transport valves is increased to increase the transfer speed of the processing material and reduce the drive load, and in the region on the rear side of the threshing chamber, in which the drive load is small, the feed angle of the debris transport valves can be reduced to reliably perform threshing without threshing leakage.

Accordingly, it is possible to adjust the feeding condition of the processing material fed by the debris transport valves to an appropriate state according to the difference in working conditions.

In the present invention, it is preferable that the threshing drum includes a first threshing processing section located at a front part, and a second threshing processing section, which is located at a rear part and has a different structure from the first threshing processing section, the plurality of front debris transport valves are provided on the top plate at a position corresponding to the first threshing processing section, and the plurality of rear debris transport valves are provided on the top plate at a position corresponding to the second threshing processing section.

According to this configuration, since the structures of the first threshing processing section and the second threshing processing section are different from each other, the methods of threshing are different. In response to such differences in the threshing processing sections, the feed angle of the front debris transport valves can be adjusted to suit the first threshing processing section, and the feed angle of the rear debris transport valves can be adjusted to suit the second threshing processing section.

In the present invention, it is preferable that each of the first angle adjusting mechanism and the second angle adjusting mechanism includes a driving motor and a link mechanism that joins the driving motor and the debris feeding valves, an inclined surface portion in a downward inclined orientation in which an outer side is located downward is formed at one end of the top plate in a left-right direction, and the first angle adjusting mechanism and the second angle adjusting mechanism are disposed in an upper space having a triangular cross-sectional shape, which is formed directly above the inclined surface portion.

According to this configuration, the first angle adjusting mechanism and the second angle adjusting mechanism are arranged effectively utilizing the upper space with a triangular cross-sectional shape that is formed at one end of the top plate in the left-right direction, whereby the first angle adjusting mechanism and the second angle adjusting mechanism can be compactly disposed with as little outward protrusion as possible.

In the present invention, it is preferable that the top plate is divided into a first top plate provided with the plurality of front debris transport valves and a second top plate provided with the plurality of rear debris transport valves, and a front debris transport valve located at a rear end among the plurality of front debris transport valves is configured to be switched to enter a region below the second top plate.

According to this configuration, since the top plate is divided, when the top plate is removed for maintenance work, the divided first top plate and second top plate are removed separately, thereby reducing the size and weight, and therefore handling is easier. As a result of such division, division surfaces are formed at an intermediate location in the front-rear direction of the threshing chamber, and therefore there is a risk that the threshing material may get caught. However, in this configuration, the threshing material can be smoothly and easily fed rearward by switching the front debris transport valve to enter the region below the second top plate.

In the present invention, it is preferable to further include: a raking section including a spiral blade at a front part of the threshing drum; and a fixed debris transport valve with a fixed feed angle above the raking section.

According to this configuration, the crops introduced into the front part of the threshing chamber can be smoothly transported while being threshed by the threshing drum due to the raking action of the raking section. At this time, since the crop is raked in by the spiral blade, if the feed inclination of the spiral blade and the feed angle by the debris transport valve differ greatly, there is a risk that the crop cannot be transferred smoothly. However, by providing a debris transport valve fixed at a feed angle suitable for the feed action above the raking section, the transfer can be performed smoothly.

In the present invention, it is preferable that a receiving net is provided extending along an outer periphery of the threshing drum, below the threshing drum, and an interval in a radial direction between a movement path of a radial outer end of the threshing drum and a radial inner end of the debris transport valve is greater than an interval in a radial direction between the movement path of the radial outer end of the threshing drum and a radial inner end of the receiving net.

According to this configuration, by narrowing the interval between the threshing drum and the receiving net to such an extent that the drive load does not become excessive, the crops can be favorably threshed. On the other hand, there is no need to narrow the interval between the threshing drum and the debris transport valve because threshing is not performed. In view of this, by increasing the interval between the threshing drum and the receiving net, it is possible to favorably transfer the crop rearward without clogging or the like.

The solution corresponding to the problem of providing a harvester capable of easily and inexpensively adjusting the interval between the receiving net and the threshing drum in such a manner that the interval is changed in various ways in the circumferential direction of the threshing drum in [Problem 1] is as follows.

A harvester according to the present invention includes: a harvesting section configured to harvest a crop in a field; and a threshing apparatus into which the crop harvested by the harvesting section is introduced and which is configured to thresh the introduced crop, in which the threshing apparatus includes: a threshing chamber into which the crop is introduced; a threshing drum that is provided in the threshing chamber so as to rotate with a threshing drum axis extending in a front-rear direction of the threshing chamber serving as a rotation center, and configured to thresh the crop introduced into the threshing chamber; and a receiving net provided in an outer periphery of a lower part of the threshing drum, the receiving net is divided into a plurality of divided receiving net bodies in a peripheral direction of the threshing drum, each of the plurality of divided receiving net bodies includes a support shaft provided extending in the front-rear direction on one end in the peripheral direction of the divided receiving net body, and is supported in such a manner as to be capable of swinging vertically with the support shaft serving as a swinging support point, the harvester further includes a single actuator linked to the plurality of divided receiving net bodies via a link mechanism, and the link mechanism swings the plurality of divided receiving net bodies vertically due to being operated by the actuator, and adjusts an interval in a radial direction of the threshing drum between the divided receiving net body and the threshing drum in the plurality of divided receiving net bodies.

According to this configuration, the interval between the receiving net and the threshing drum (the interval in the radial direction of the threshing drum) in the plurality of divided receiving net bodies can be adjusted for each divided receiving net body, and therefore the interval can be adjusted in such a manner as to change in various ways in the peripheral direction of the threshing drum. Since a plurality of divided receiving net bodies are operated by one actuator, the number of operations for operating the actuators can be reduced, the required number of actuators can be reduced, and the interval adjustment can be performed easily and inexpensively, compared to the case of operating the plurality of divided receiving net bodies with separate actuators.

In the present invention, it is preferable that the support shaft of the divided receiving net body is provided on an end located downstream in a threshing material movement direction in the divided receiving net body, out of both ends in the peripheral direction of the divided receiving net body.

According to this configuration, since the threshing material moves toward the support shaft from the side opposite to the support shaft in the divided receiving net body, a large amount of threshing material is located between the divided receiving net body and the threshing drum on the side opposite to the shaft, relative to the amount between the divided receiving net body and the threshing drum on the support shaft side. When the interval between the receiving net and the threshing drum is adjusted, the interval between the divided receiving net body and the threshing drum on the side opposite to the support shaft becomes wider than the interval between the divided receiving net body and the threshing drum on the support shaft side, and therefore although the interval between the receiving net and the threshing drum is adjusted by vertically swinging the divided receiving net body, threshing is performed without clogging even if a large amount of threshing material is introduced into the threshing chamber.

In the present invention, it is preferable that the link mechanism is joined to an end opposite to where the support shaft is located in each of the plurality of divided receiving net bodies.

According to this configuration, since the operating force of the link mechanism can be easily transmitted to the divided receiving net body, the divided receiving net body can be smoothly swung by the link mechanism.

In the present invention, it is preferable that the link mechanism includes: a parallel link that is moved in parallel by the actuator; and a swinging link that has a free end engaged with the parallel link and performs output to the divided receiving net body by being swung by the parallel link, the parallel link and the free end are engaged by an elongated groove provided in one of the parallel link and the free end, and a linking member supported by the other of the parallel link and the free end while being slidably inserted in the elongated groove, and the linking member is rotatably supported by the other of the parallel link and the free end while being formed in a non-circular shape so as to be non-rotatably inserted in the elongated groove.

According to this configuration, when the parallel link is moved in parallel by the actuator, the swinging link is swung due to the motive power of the parallel link being transmitted to the swinging link while the linking member slides in the elongated groove, and motive power is output to the divided receiving net body. If the linking member is in a circular shape and transmits motive power between the parallel link and the swinging link while the linking member rotates in the elongated groove, the linking member comes into point contact with the inner wall of the elongated groove, and as a result, the linking member and the inner wall of the groove are easily worn. According to this configuration, the linking member is in a non-circular shape and cannot rotate with respect to the elongated groove, but is rotatably supported by the parallel link or the free end (swinging link) to transmit motive power between the parallel link and the swinging link, that is, the linking member transmits motive power while being in line contact with the inner wall of the elongated groove, and therefore the linking member and the inner wall of the groove can be made less likely to wear.

The solution corresponding to [Problem 3] is as follows.

The characteristic configuration of the threshing apparatus according to the present invention includes: a threshing chamber into which a reaped grain culm is introduced; a threshing drum rotatably provided in the threshing chamber; a receiving net provided along an outer periphery of the threshing drum, below the threshing drum; and a sorting apparatus that is located below the receiving net and receives and sorts threshing material leaked from the receiving net while swinging and transferring the threshing material, in which an upstream end of the receiving net located on an upstream side in a rotation direction of the threshing drum is located at a position lower than a rotation axis of the threshing drum, and a side wall portion is included at the upstream side in the rotation direction of the threshing chamber relative to the upstream end of the receiving net, and a downstream end of the receiving net located on a downstream side in the rotation direction of the threshing drum is located at a position higher than the rotation axis of the threshing drum.

According to the present invention, the upstream end of the receiving net is located at a position lower than the rotation axis of the threshing drum, and the downstream side in the rotation direction relative to the upstream end of the receiving net is covered by the side wall. In the portion of the sorting apparatus located on the upstream side in the rotation direction of the threshing drum in the receiving net, the leakage area of the receiving net per unit width in the left-right direction is smaller than in the conventional configuration, and the amount of threshing material that falls on the sorting apparatus can be reduced. That is, it is possible to reduce the variation in the amount of processing material in the sorting apparatus and improve the sorting accuracy.

Since the downstream end of the receiving net is located higher than the rotation axis of the threshing drum, the region from the upstream end to the downstream end of the receiving net is a wide range similar to the conventional one. As a result, the crops can be favorably threshed in cooperation with the threshing drum, and there is no risk of lowering the threshing capacity.

Accordingly, it is possible to improve the sorting accuracy when sorting the threshing material without lowering the threshing capacity.

In the present invention, it is preferable that in a view in a rotation axis direction of the threshing drum, the sorting section is arranged biased to one side in a left-right direction with respect to the threshing drum.

According to this configuration, due to the sorting apparatus being biased in the left-right direction with respect to the threshing drum, for example, when the location with the most threshing material is moved to the center instead of the end in the left-right direction of the sorting apparatus, the processing material is distributed to the left and right and variation can be reduced.

In the present invention, it is preferable that the sorting apparatus is arranged biased such that a center position in the left-right direction of the sorting apparatus is a position biased toward the downstream end of the receiving net with respect to the rotation axis of the threshing drum.

According to this configuration, as described above, it is possible to reduce the amount of threshing material at the location corresponding to the upstream side of the receiving net in the sorting apparatus, and furthermore, since the leakage area of the receiving net is wider at the portion corresponding to the downstream end of the receiving net, the threshing material leaks over a wide range. In view of this, by biasing the sorting apparatus toward the downstream end of the receiving net, it is possible to reduce the variation in the threshing material overall.

In the present invention, it is preferable that the upstream end of the receiving net is located inward in the left-right direction with respect to a movement path outer end position that is located on an outermost side in the left-right direction of a movement path of a radial outer end of the threshing drum and is close to the upstream end.

According to this configuration, the upstream end of the receiving net is located at a position sufficiently lower than the rotation axis of the threshing drum to the extent that it falls within the range of the movement path of the radial outer end of the threshing drum in a plan view, and therefore, it is possible to further reduce the variation in the amount of processing material to be processed.

### BRIEF DESCRIPTION OF THE DRAWINGS

FIG. 1 is a diagram showing a first embodiment (hereinafter the same up to FIG. 9), and is a left side view showing an entire combine with a threshing section cut away.

FIG. 2 is a side view showing an entire threshing drum.

FIG. 3 is a cross-sectional view of a first threshing processing section.

FIG. 4 is a cross-sectional view of a second threshing processing section.

FIG. 5 is a front view showing a divided receiving net body, the threshing drum, and an interval adjusting mechanism with an interval between the divided receiving net body and the threshing drum adjusted to be narrow.

FIG. 6 is a front view showing the divided receiving net body, the threshing drum, and the interval adjusting mechanism with the interval between the divided receiving net body and the threshing drum adjusted to be wide.

FIG. 7 is a plan view showing a receiving net and the interval adjusting mechanism.

FIG. 8 is a side view showing an interval adjusting mechanism including another embodiment.

FIG. 9 is a diagram showing the operation of the interval adjustment mechanism including another embodiment.

FIG. 10 is a diagram showing a second embodiment (hereinafter the same up to FIG. 13), and is a front view showing a receiving net, a threshing drum and an interval adjusting mechanism with an interval between the receiving net and the threshing drum adjusted to be narrow.

FIG. 11 is a front view showing the receiving net, the threshing drum, and the interval adjusting mechanism with the interval between the receiving net and the threshing drum adjusted to be wide.

FIG. 12 is a plan view showing the receiving net and the interval adjusting mechanism.

FIG. 13 is a front view showing engagement between a parallel link and a swinging link.

FIG. 14 is a diagram showing a third embodiment (hereinafter the same up to FIG. 27), and is an overall side view of a combine.

FIG. 15 is a transverse cross-sectional plan view of a threshing apparatus.

FIG. 16 is a longitudinal cross-sectional side view of the threshing apparatus.

FIG. 17 is a side view of a second threshing drum.

FIG. 18 is a cross-sectional view taken along line XVIII-XVIII of FIG. 16.

FIG. 19 is a cross-sectional view taken along line XIX-XIX of FIG. 16.

FIG. 20 is a longitudinal cross-sectional front view of the threshing apparatus.

FIG. 21 is a longitudinal cross-sectional front view showing a first threshing tooth.

FIG. 22 is a partial perspective view of first threshing teeth.

FIG. 23 is a plan view showing an attached state of a second threshing tooth.

FIG. 24 is a perspective view showing an attached state of the second threshing tooth.

FIG. 25 is a plan view showing a supported state of a debris transport valve.

FIG. 26 is a longitudinal cross-sectional front view showing a supported state of the debris transport valve.

FIG. 27 is a plan view of a first angle adjusting mechanism.

FIG. 28 is a diagram showing a fourth embodiment, and is a longitudinal cross-sectional front view of the threshing apparatus.

### DESCRIPTION OF THE INVENTION

### First Embodiment

An embodiment (first embodiment), which is an example of the present invention, will be described below with reference to the drawings.

An embodiment, which is an example of the present invention, will be described below with reference to the drawings.

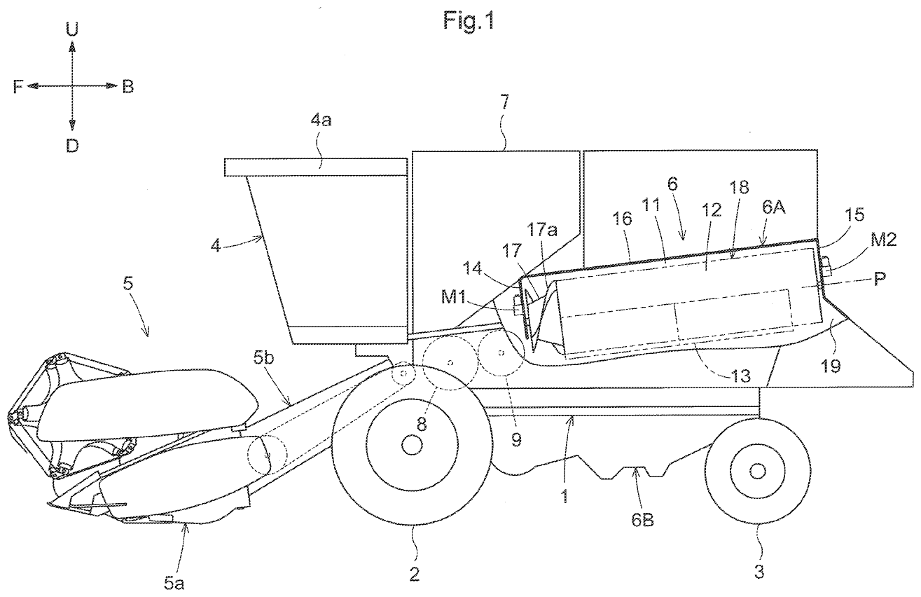

Note that in the following description, regarding a traveling machine body of a combine (an example of a “harvester”), the direction of arrow F shown in FIG. 1 is “body frontward”, the direction of arrow B is “body rearward”, the direction of arrow U is “body upward”, the direction of arrow D is “body downward”, and the direction toward the front side of the page is “body leftward”, and the direction toward the back side of the page is “body rightward”.

Overall Configuration of Combine in First Embodiment

As shown in FIG. 1, a combine harvester includes a traveling machine body that has a body frame 1 formed by joining a plurality of steel materials such as rectangular pipe materials, a pair of left and right front wheels 2 drivably provided at the front part of the body frame 1, and a pair of left and right rear wheels 3 steerably provided at the rear part of the body frame 1. The front part of the traveling machine body includes a driving section 4 and a harvesting/conveying apparatus 5. The driving section 4 includes a cabin 4a that covers a boarding space. The harvesting/conveying apparatus 5 includes a harvesting section 5a that is provided at the front part of the harvesting/conveying apparatus 5 and is for reaping and harvesting grain culms such as rice and wheat planted in a field, and a feeder 5b that is provided at the rear part of the harvesting/conveying apparatus 5, and conveys the reaped grain culms harvested by the harvesting section 5a to a predetermined location of the traveling machine body. The rear part of the traveling machine body is provided with a threshing apparatus 6 that receives supply of whole culms from the root base to the ear tip of the reaped grain culms conveyed by the feeder 5b, threshes the supplied reaped grain culms, and sorts the threshing material, and a grain tank 7 that collects and stores the grain obtained by the threshing apparatus 6. Between the feeder 5b and the threshing apparatus 6, a pre-threshing section 8 that threshes the reaped grain culms conveyed by the feeder 5b and an intermediate conveying apparatus 9 that receives the reaped grain culms discharged from the pre-threshing section 8 and supplies the received reaped grain culms to the threshing apparatus 6 are provided.

Configuration of Threshing Apparatus in First Embodiment

In describing the threshing apparatus 6, the processing start end of the threshing apparatus 6 [the culm input side (the left side of the paper surface of FIG. 1)] is defined as the “front”, and the processing end side of the threshing apparatus 6 [the culm discharge side (the right side of the paper surface of FIG. 1)] is defined as the “rear”’.

As shown in FIG. 1, the threshing apparatus 6 includes a threshing section 6A that is provided in an upper part of the threshing apparatus 6 and threshes reaped grain culms supplied by the intermediate conveying apparatus 9, and a sorting section 6B that is provided below the threshing apparatus 6 and sorts the threshing material. In the threshing apparatus 6, the threshing direction in the threshing section 6A is set in such a manner as to coincide with the front-rear direction of the traveling machine body, and in such a manner that the upstream side in the threshing direction is located on the front side of the traveling machine body.

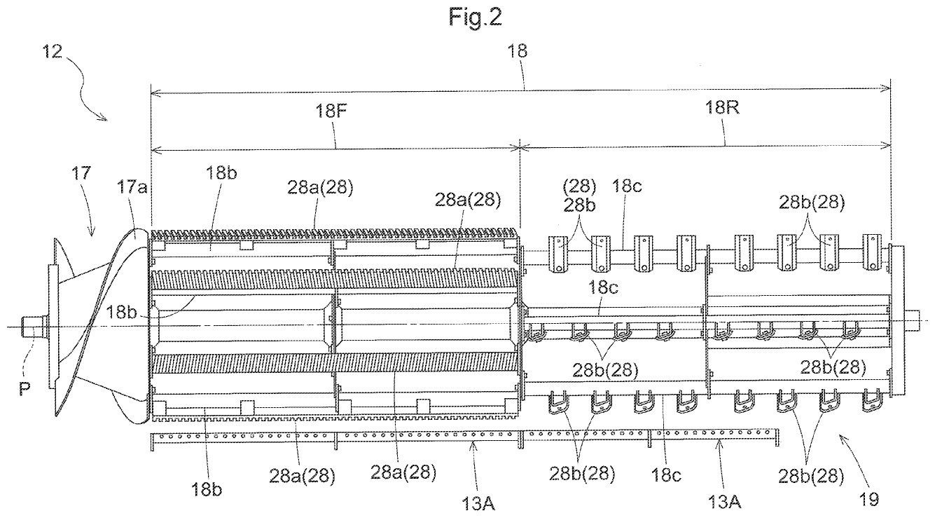

As shown in FIG. 1, the threshing section 6A includes a threshing chamber 11 formed in the upper part of the threshing apparatus 6, a threshing drum 12 provided in the threshing chamber 11, and a receiving net 13 provided in the outer periphery of the lower part of the threshing drum 12. As shown in FIG. 2, the receiving net 13 is provided in a region below the threshing drum 12 in the periphery of the threshing drum 12. In this embodiment, the receiving net 13 is constituted by a lattice net.

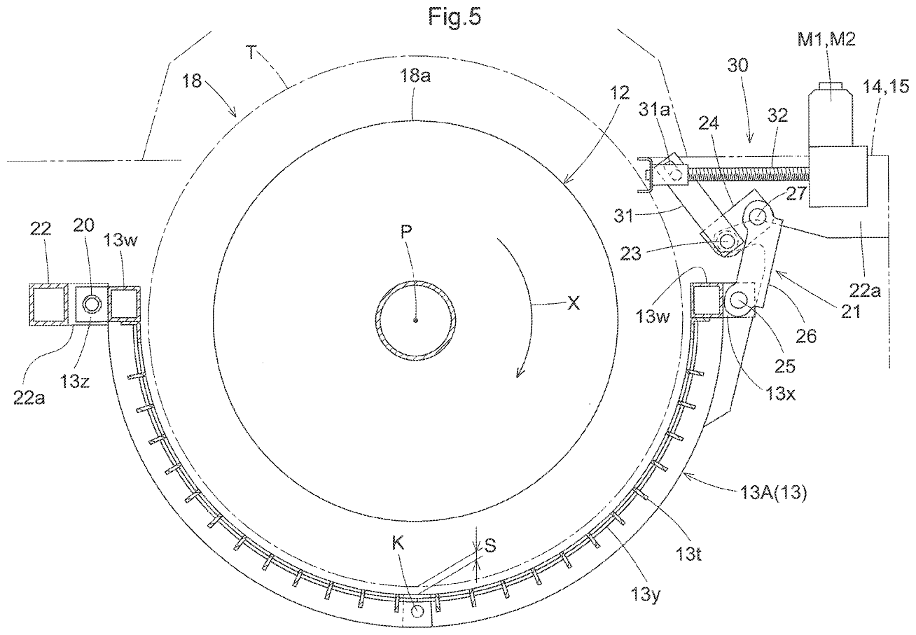

As shown in FIG. 1, the threshing drum 12 is provided in the threshing chamber 11 in an orientation along the front-rear direction of the threshing chamber 11, and is driven to rotate in a clockwise direction in a view from the front (in the direction indicated by arrow X in FIG. 5) with the threshing drum axis P in the direction extending along the front-rear direction of the threshing chamber 11 as a rotation axis. The threshing chamber 11 is formed by a front wall 14 supporting the threshing drum 12, a rear wall 15 supporting the threshing drum 12, a top plate 16 located above the threshing drum 12, the receiving net 13, and the like. As shown in FIG. 1, the threshing drum 12 includes a raking section 17 provided at the front part of the threshing drum 12 and a threshing processing section 18 provided at the rear part of the threshing drum 12. The threshing processing section 18 is provided to be continuous with the rear part of the raking section 17. The threshing processing section 18 includes a threshing drum main body 18a, and threshing teeth 28 provided in a standing manner outward in the threshing drum radial direction from the peripheral part of the threshing drum main body 18a.

In the threshing section 6A, the intermediate conveying apparatus 9 introduces all the harvested grain culms from the root base to the ear tip into the front part of the threshing chamber 11, and the introduced threshing material is raked into the threshing processing section 18 by a spiral blade 17a of the raking section 17 and threshed by the threshing teeth 28 and the receiving net 13. The threshing material to be threshed is threshed while being transferred toward the rear of the threshing chamber 11 by the rotating threshing teeth 28. The grain obtained through the threshing leaks from the receiving net 13 and is received by the sorting section 6B. Threshing material such as threshed grain culms and cut straw generated through the threshing are discharged to the outside of the threshing chamber 11 from a debris discharge portion 19 located at the rear lower portion of the threshing chamber 11.

Structure of Threshing Drum in First Embodiment

As shown in FIG. 2, the threshing drum 12 includes the raking section 17 provided at the front part of the threshing drum 12 and the threshing processing section 18 provided rearward of the raking section 17 while joined to the rear part of the raking section 17. The threshing processing section 18 includes a first threshing processing section 18F provided at the rear part of the threshing processing section 18 and a second threshing processing section 18R provided rearward of the first threshing processing section 18F while being joined to the rear part of the first threshing processing section 18F.

As shown in FIG. 2, the first threshing processing section 18F includes a plurality of front frame bodies 18b that are arranged side by side in the peripheral direction of the threshing drum and form the threshing drum main body 18a, and first threshing teeth 28a provided on the front frame bodies 18b. The second threshing processing section 18R includes a plurality of rear frame bodies 18c that are arranged side by side in the peripheral direction of the threshing drum and form the threshing drum main body 18a, and second threshing teeth 28b provided at a plurality of locations in the front-rear direction of the rear frame bodies 18c. The first threshing teeth 28a and the second threshing teeth 28b are configured as threshing teeth of different shapes.

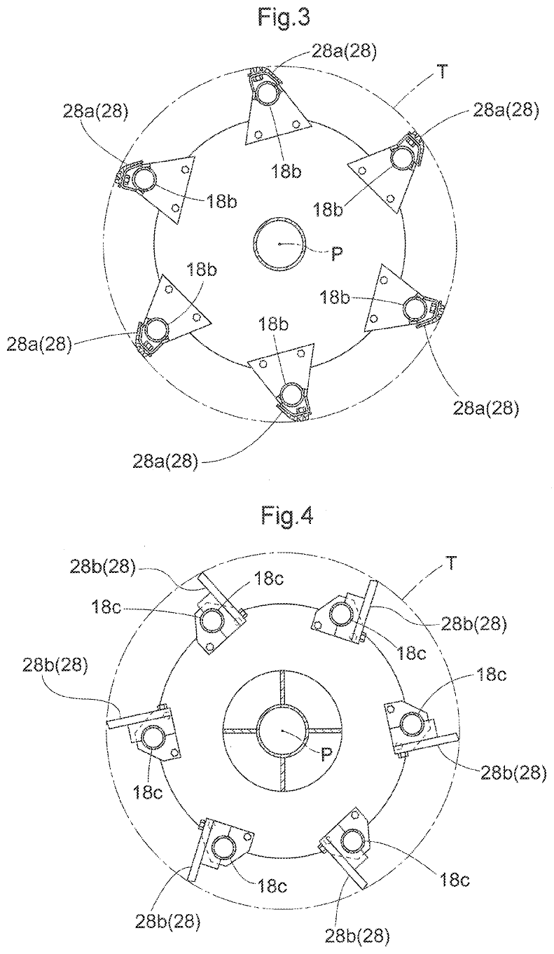

Specifically, as shown in FIGS. 2 and 3, the first threshing teeth 28a have recesses and protrusions formed on their surface, and perform a threshing action on reaped grain culms serving as threshing material with use of the shape of the recesses and protrusions on the surface. The first threshing teeth 28a have a large number of recesses and protrusions formed on their surface, and are configured as rasp threshing teeth that perform a threshing action on a crop with use of the shape of the recesses and protrusions on the surface. As shown in FIGS. 2 and 4, the second threshing teeth 28b extend in a rod shape outward in the threshing drum radial direction from the rear frame body 18c. The second threshing teeth 28b are constituted by plate bodies having a substantially U-shaped cross section, and are in a vertically-elongated shape that is elongated in a threshing drum radial direction.

Adjustment of Interval between Receiving Net and Threshing Drum in First Embodiment

When crops with different properties are harvested, the amount of crops supplied to the threshing apparatus 6 is different, or the like, it is preferable to adjust the interval S in the threshing drum radial direction between the receiving net 13 and the threshing drum 12. The receiving net 13 is divided into a plurality of divided receiving net bodies 13A in the front-rear direction of the threshing chamber 11, and the interval S between the receiving net 13 and the threshing drum 12 can be adjusted such that the interval S is changed in each divided receiving net body 13A.

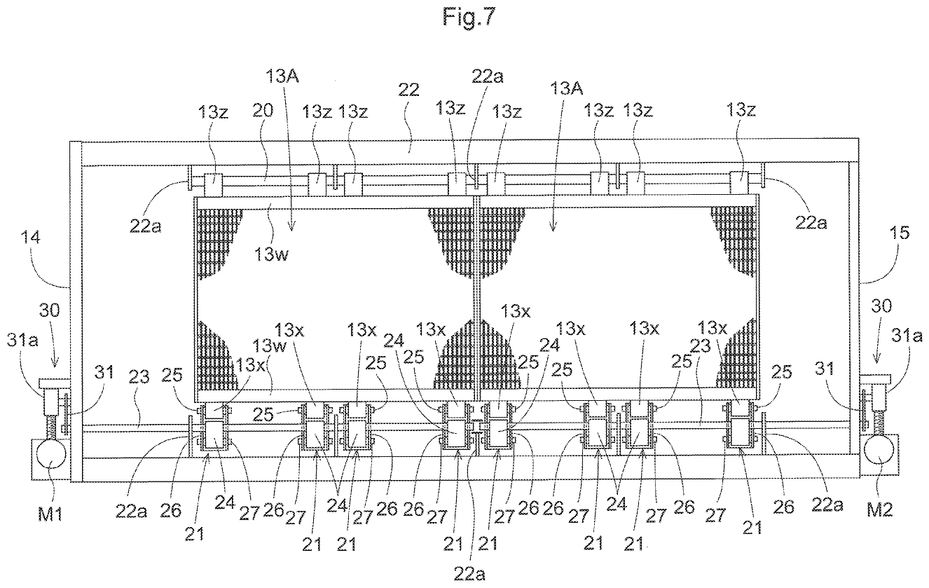

Specifically, in this embodiment, the receiving net 13 is divided into two divided receiving net bodies 13A in the front-rear direction of the threshing chamber 11, as shown in FIG. 5. As shown in FIG. 2, the receiving net 13 is divided into two divided receiving net bodies 13A at a location corresponding to the branch point between the first threshing processing section 18F and the second threshing processing section 18R in the threshing processing section 18. The front divided receiving net body 13A of the two divided receiving net bodies 13A is provided corresponding to the first threshing processing section 18F, and the rear divided receiving net body 13A of the two divided receiving net bodies 13A is provided corresponding to the second threshing processing section 18R. The rear end of the rear divided receiving net body 13A is located frontward relative to the rear end of the second threshing processing section 18R. As shown in FIGS. 5 and 7, each divided receiving net body 13A includes a receiving net main body including a plurality of vertical bars 13t arranged side by side in the threshing drum peripheral direction and a plurality of horizontal bars 13y arranged side by side in the threshing drum front-rear direction, and a frame body portion 13w for retaining the shape of the receiving net main body. The vertical bars 13t are constituted by strip members extending in the longitudinal direction of the threshing drum. The horizontal bars 13y are constituted by bar members formed in an arc shape along the threshing drum peripheral direction.

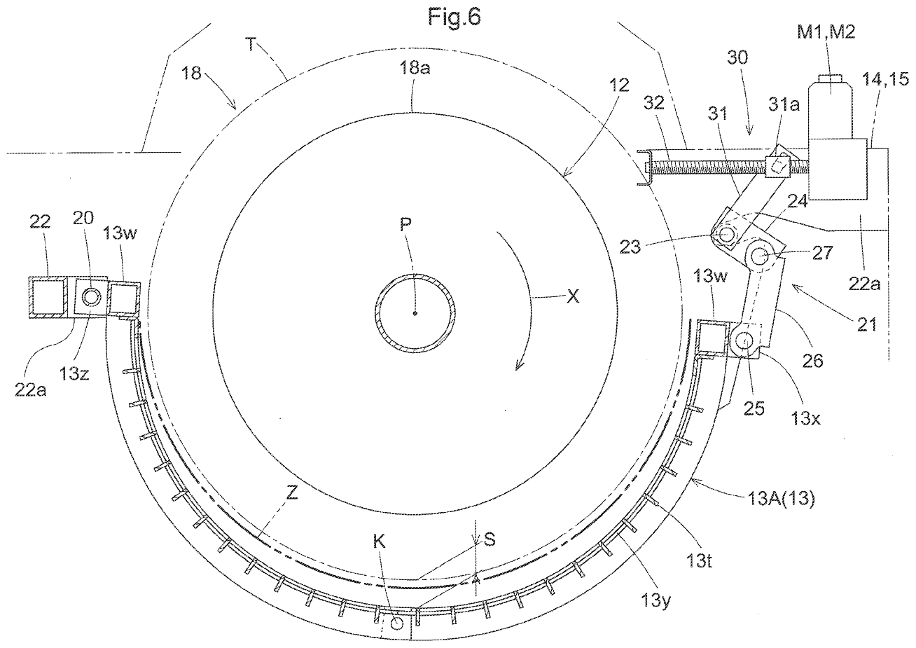

In FIGS. 5 and 6, illustration of the threshing teeth 28 is omitted. T in FIGS. 5 and 6 is the rotation path of the tip of the threshing teeth 28. As shown in FIGS. 5 and 7, the front and rear divided receiving net bodies 13A are supported by a support portion 22a of the threshing apparatus 6 via a support shaft 20 provided at one end in the threshing drum peripheral direction of the divided receiving net body 13A and support link mechanisms 21 provided at the other end in the threshing drum peripheral direction of the divided receiving net body 13A. The support portion 22a is provided on a threshing frame 22. The support link mechanisms 21 are provided at joining portions 13x of the divided receiving net body 13A. The support link mechanisms 21 are provided at a plurality of locations in the front-rear direction of the frame body portion 13w of the divided receiving net body 13A. In this embodiment, the support link mechanisms 21 are provided at four locations in the front-rear direction of the frame body portion 13w. The support shaft 20 is constituted by a pipe member extending in the front-rear direction of the threshing chamber, and is joined to the support portion 22a of the threshing apparatus 6 and joining portions 13z of the divided receiving net body 13A. The joining portions 13z are provided at a plurality of locations in the front-rear direction of the frame body portion 13w. In this embodiment, the joining portions 13z are provided at four locations in the front-rear direction of the frame body portion 13w. As shown in FIGS. 2 and 4, each of the support link mechanisms 21 at a plurality of locations includes a first swinging link 24 supported by the support portion 22a via a link support shaft 23 so as to be capable of swinging vertically, and a second swinging link 26 that is swingably joined via a joining pin 25 to the joining portion 13x. The first swinging link 24 and the second swinging link 26 are linked with each other via a linking pin 27 so as to be swingable relative to each other. The link support shaft 23 of the support link mechanisms 21 in each of the front and rear divided receiving net bodies 13A is constituted by one shaft extending in the front-rear direction of the threshing chamber 11 so as to be a common link support shaft 23 for the support link mechanisms 21 at a plurality of locations. Each of the front and rear divided receiving net bodies 13A is supported while being able to swing vertically with respect to the threshing drum 12, with the support shaft 20 serving as a swinging support point, by bending and stretching the support link mechanisms 21 at a plurality of locations. In the front and rear divided receiving net bodies 13A, each support link mechanism 21 is bent and stretched, whereby the support link mechanisms 21 swing vertically with respect to the threshing drum 12 and the interval S between the divided receiving net body 13A and the threshing drum 12 is changed. The interval S is the interval between the horizontal bars 13y of the divided receiving net body 13A and the rotation path T of the tip of the threshing teeth. A bending point K is provided at an intermediate portion in the threshing drum peripheral direction of the front and rear divided receiving net bodies 13A. As shown in FIGS. 5 and 6, when the interval S of the divided receiving net body 13A is adjusted, the portion of the divided receiving net body 13A closer to the support link mechanisms 21 relative to the bending point K swings with the bending point K serving as a swinging support point with respect to the portion of the divided receiving net body 13A closer to the support shaft 20 relative to the bending point K, and the adjustment allowance of the interval S at the portion of the divided receiving net body 13A closer to the support link mechanism 21 relative to the bending point K is greater compared to the case where the divided receiving net body 13A that does not include a bending point K swings.

As shown in FIG. 7, an interval adjusting mechanism 30 for adjusting the interval S between the divided receiving net body 13A and the threshing drum 12 is connected to each of the front and rear divided receiving net bodies 13A. The adjustment of the interval S in the front divided receiving net body 13A can be performed by the interval adjusting mechanism 30 dedicated to the front divided receiving net body, and the adjustment of the interval S in the rear divided receiving net body 13A can be performed by the interval adjustment mechanism 30 dedicated to the rear divided receiving net body. The adjustment of the interval S of the divided receiving net bodies 13A can be performed for each of the front and rear divided receiving net bodies.

As shown in FIGS. 5 and 7, the interval adjusting mechanism 30 of the front divided receiving net body 13A includes the support link mechanisms 21 at a plurality of locations of the front divided receiving net body 13A, an operation arm 31 that is linked to the first swinging link 24 of each support link mechanism 21 of the front divided receiving net body 13A by being supported by the link support shaft 23 of the front divided receiving net body 13A, and a first electric motor M1 linked to the operation arm 31. The linking between the operation arm 31 and the first electric motor M1 is achieved by inserting a screw shaft 32 that can be driven to rotate forward and in reverse by the first electric motor M1, in a screw hole in the joining portion 31a that can be swung by the swinging arm 31. As shown in FIG. 7, the operation arm 31 and the first electric motor M1 are provided outside the front wall 14 forming the threshing chamber 11. Inspection of the first electric motor M1 and the like can be performed outside the front wall 14.

The interval adjustment mechanism 30 of the rear divided receiving net body 13A is configured in the same manner as the interval adjusting mechanism 30 of the front divided receiving net body 13A. As shown in FIGS. 5 and 7, the interval adjusting mechanism 30 of the rear divided receiving net body 13A includes the support link mechanisms 21 at a plurality of locations of the rear divided receiving net body 13a, the operation arm 31 supported by the link support shaft 23 held in common by each of the support link mechanisms 21 of the rear divided receiving net bodies 13a, and a second electric motor M2 linked with the operation arm 31. The link between the operation arm 31 and the second electric motor M2 is achieved by the screw shaft 32 that can be driven to rotate forward and in reverse by the second electric motor M2, and a joining portion 31a rotatably provided on the operation arm 31 with a screw hole into which the screw shaft 32 is inserted. The operation arm 31 and the second electric motor M2 are provided outside the rear wall 15 forming the threshing chamber 11, as shown in FIG. 7. Inspection of the second electric motor M2 and the like can be performed outside the rear wall 15.

The interval adjusting mechanism 30 of the front divided receiving net body 13A is operated by the first electric motor M1 to operate the support link mechanisms 21 at a plurality of locations and adjust the interval between the front divided receiving net body 13A and the threshing drum 12, and the interval adjusting mechanism 30 of the rear divided receiving net body 13A is operated by the second electric motor M2 to operate the support link mechanisms 21 at a plurality of locations and adjust the interval between the rear divided receiving net body 13A and the threshing drum 12. FIG. 5 is a front view showing the divided receiving net body 13A, the threshing drum 12, and the interval adjusting mechanism 30 with the interval S between the divided receiving net body 13A and the threshing drum 12 adjusted to be narrow. FIG. 6 is a front view showing the divided receiving net body 13A, the threshing drum 12, and the interval adjusting mechanism 30 with the interval S between the divided receiving net body 13A and the threshing drum 12 adjusted to be wide. A two-dot chain line Z shown in FIG. 6 indicates the interval S with the width in the adjusted state shown in FIG. 5. As shown in FIGS. 5 and 6, in the interval adjusting mechanism 30 of the front divided receiving net body 13A and in the interval adjusting mechanism 30 of the rear divided receiving net body 13A, when the joining portion 31a of the operation arm 31 is pushed and pulled by the screw shaft 32, the operation arm 31 is swung with the link support shaft 23 serving as the swinging support point, and the link support shaft 23 is rotated by the operation arm 31, whereby the first swinging links 24 in the support link mechanisms 21 at a plurality of locations are swung, and the support link mechanisms 21 at a plurality of locations are operated to bend and stretch, the support link mechanism 21 swings the divided receiving net body 13A vertically, and bends and stretches the divided receiving net body 13A with the bending point K.at the center of bending and stretching, whereby the interval S between the divided receiving net body 13A and the threshing drum 12 is adjusted.

The interval between the divided receiving net body 13A and the threshing drum 12 can be adjusted for each divided receiving net body. For example, in the interval adjusting mechanism 30 of the front divided receiving net body 13A and the interval adjusting mechanism 30 of the rear divided receiving net body 13A, the first electric motor M1 and the second electric motor M2 are driven in different rotation directions. As a result, the interval S between one of the front and rear divided receiving net bodies 13A and the threshing drum 12 is narrowed, and the interval S between the other of the front and rear divided receiving net bodies 13A and the threshing drum 12 widens. By driving the first electric motor M1 and the second electric motor M2 so as to rotate by different amounts of rotation, the adjustment allowance of the interval S between the front divided receiving net body 13A and the threshing drum 12 and the adjustment allowance for the interval S between the rear divided receiving net body 13A and the threshing drum 12 are different from each other.

### Other Embodiments of First Embodiment

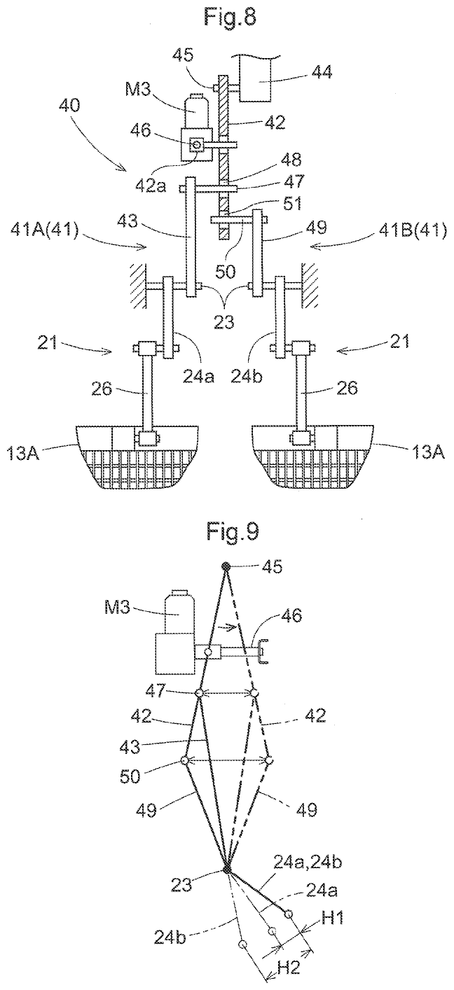

(1) FIG. 8 is a perspective view showing an interval adjusting mechanism 40 including another embodiment. The interval adjusting mechanism 40 including another embodiment includes a third electric motor M3 serving as one actuator, and a link mechanism 41 that transmits the motive power of the third electric motor M3 to the front divided receiving net body 13A as operating power, and transmits the motive power of the third electric motor M3 to the rear divided receiving net body 13A as operating power. The link mechanism 41 includes a front link mechanism portion 41A that transmits the motive power of the third electric motor M3 to the front divided receiving net body 13A, and a rear link mechanism portion 41B that transmits the motive power of the third electric motor M3 to the rear divided receiving net body 13A.

As shown in FIG. 8, the front link mechanism portion 41A includes an operation link 42 linked to the third electric motor M3, and a front joining link 43 linking the operation link 42 to the first swinging link 24a in the support link mechanism 21 of the front divided receiving net body 13A.

The operating link 42 is swingably supported by a support portion 44 provided in the threshing apparatus 6 via a support pin 45. A screw shaft 46 that can be rotated forward and in reverse by the third electric motor M3 is inserted in a screw hole of a joining portion 42a rotatably provided in the operation link 42, whereby the operation link 42 and the third electric motor M3 are linked together.

One end of the front joining link 43 is engaged with the free end of the operating link 42 via a joining pin 47, and the other end of the front joining link 43 is joined to the link support shaft 23 of the first swinging link 24 of the front divided receiving net body 13A, whereby the operating link 42 and the first swinging link 24 are linked to each other. The joining pin 47 is slidably and rotatably inserted in a first elongated hole 48 provided in the operating link 42.

As shown in FIG. 8, the rear link mechanism portion 41B includes an operation link 42 and a rear joining link 49 that link the operation link 42 to the first swinging link 24 in the support link mechanism 21 of the rear divided receiving net body 13A.

One end of the rear joining link 49 is engaged with the free end of the operating link 42 via a joining pin 50, and the other end of the rear joining link 49 is engaged with the link support shaft 23 of the first swinging link 24b of the rear divided receiving net body 13A, whereby the operating link 42 and the first swinging link 24 are linked to each other. The joining pin 50 is slidably and rotatably inserted in a second elongated hole 51 provided in the operating link 42.

As shown in FIGS. 8 and 9, the second elongated hole 51 is provided closer to the free end of the operating link 42 relative to the first elongated hole 48. That is, the link mechanism 41 is configured such that a link ratio provided between the operating link 42 and the first swinging link 24 so that the front link mechanism portion 41A transmits the motive power of the third electric motor M3 to the front divided receiving net body 13A, and a link ratio provided between the operation link 42 and the first swinging link 24 so that the rear link mechanism portion 41B transmits the motive power of the third electric motor M3 to the rear divided receiving net body 13A are different from each other. An operating stroke H1 at the free end of the first swinging link 24a that transmits the operating power to the front divided receiving net body 13A due to the operating link 42 being swung by a certain angle and an operating stroke H2 at the free end of the first swinging link 24b that transmits the operating power to the rear divided receiving net body 13A due to the operating link 42 being swung by a certain angle are different from each other, and the adjustment allowance for the interval S between the front divided receiving net body 13A and the threshing drum 12 that is performed due to the operating link 42 being swung by a certain angle and the adjustment allowance for the interval S between the rear divided receiving net body 13A and the threshing drum 12 that is performed due to the operating link 42 being swung by a certain angle are different from each other.

In the interval adjusting mechanism 40 having another embodiment, the motive power of the third electric motor M3 is transmitted to the front divided receiving net body 13A as operating power due to the front link mechanism portion 41A of the link mechanism 41 transmitting the motive power of the third electric motor M3 to the support link mechanism 21 of the front divided receiving net body 13A, the motive power of the third electric motor M3 is transmitted to the rear divided receiving net body 13A as operating power due to the rear link mechanism portion 41B of the link mechanism 41 transmitting the motive power of the third electric motor M3 to the support link mechanism 21 of the rear divided receiving net body 13A, and thus the interval between the front divided receiving net body 13a and the threshing drum 12 is adjusted, and the interval between the rear divided receiving net body 13A and the threshing drum 12 is adjusted. The same third electric motor M3 adjusts the interval between the front divided receiving net body 13a and the threshing drum 12 and the interval between the rear divided receiving net body 13A and the threshing drum 12.

In the interval adjusting mechanism 40 having another embodiment, the interval between the front and rear divided receiving net bodies 13A and the threshing drum 12 is adjusted using the motive power of the same third electric motor M3, but the interval between the front and rear divided receiving net bodies 13A and the threshing drum 12 is adjusted in a state in which the link ratio by which the front link mechanism portion 41A transmits the motive power of the third electric motor M3 to the front divided receiving net body 13A and the link ratio by which the rear link mechanism portion 41B transmits the motive power of the third electric motor M3 to the rear divided receiving net body 13A are different from each other, and the adjustment allowance between the threshing drum 12 and the front divided receiving net body 13A and the adjustment allowance for the threshing drum 12 and the rear divided receiving net body 13A are different from each other.

(2) In the above-described embodiment, an example in which the receiving net 13 is divided into two divided receiving net bodies 13A was shown, but the receiving net 13 may be divided into three or more divided receiving net bodies.

(3) In the above-described embodiment, an example was shown in which the bending point K is provided in the divided receiving net body 13A, but the bending point K need not be provided.

(4) In the above-described embodiment, an example was shown in which the threshing drum 12 provided with threshing teeth of different shapes in the threshing processing section 18 is adopted, but a threshing drum in which all of the threshing teeth have the same shape in the threshing processing section 18 may be adopted.

(5) In the above-described embodiment, the receiving net 13 constituted by a lattice receiving net is adopted, but other than a lattice net, it is possible to adopt a crimp net, a resin net, or the like.

(6) In the above-described embodiment, an example was shown in which the first electric motor M1 is provided outside the front wall 14, and the second electric motor M2 is provided outside the rear wall 15, but the first electric motor M1 and the second electric motor M2 may be provided at any position. Also, the third electric motor M3 may be provided at any position. In the above-described embodiment, an example was shown in which the first electric motor M1, the second electric motor M2, and the third electric motor M3 are adopted, but a hydraulic actuator such as a hydraulic cylinder may be adopted in place of an electric motor.

(7) In the above-described embodiment, the combine having the pre-threshing section 8 and the intermediate conveying apparatus 9 was illustrated, but there is no limitation to this. A configuration of the combine may be adopted in which the reaped grain culms are directly supplied from the feeder 5b to the threshing apparatus 6 without the pre-threshing section 8 and the intermediate conveying apparatus 9.

### Second Embodiment

An embodiment (second embodiment) that is an example of the present invention will be described below with reference to the drawings. Note that the overall configuration of the combine, the configuration of the threshing apparatus, and the configuration of the threshing drum are the same as in the first embodiment. Only the differences from the first embodiment will be described below, and description of configurations that are the same will be omitted.

Adjustment of Interval between Receiving Net and Threshing Drum in Second Embodiment

When crops with different properties are harvested, the amount of crops supplied to the threshing apparatus 6 is different, or the like, it is preferable to adjust the interval S in the threshing drum radial direction between the receiving net 13 and the threshing drum 12. The receiving net 13 is divided into a plurality of divided receiving net bodies 13Ain the peripheral direction of the threshing drum 12, and the interval S between the receiving net 13 and the threshing drum 12 can be adjusted in such a manner that the interval between the receiving net 13 and the threshing drum 12 is changed for each divided receiving net body 13A.

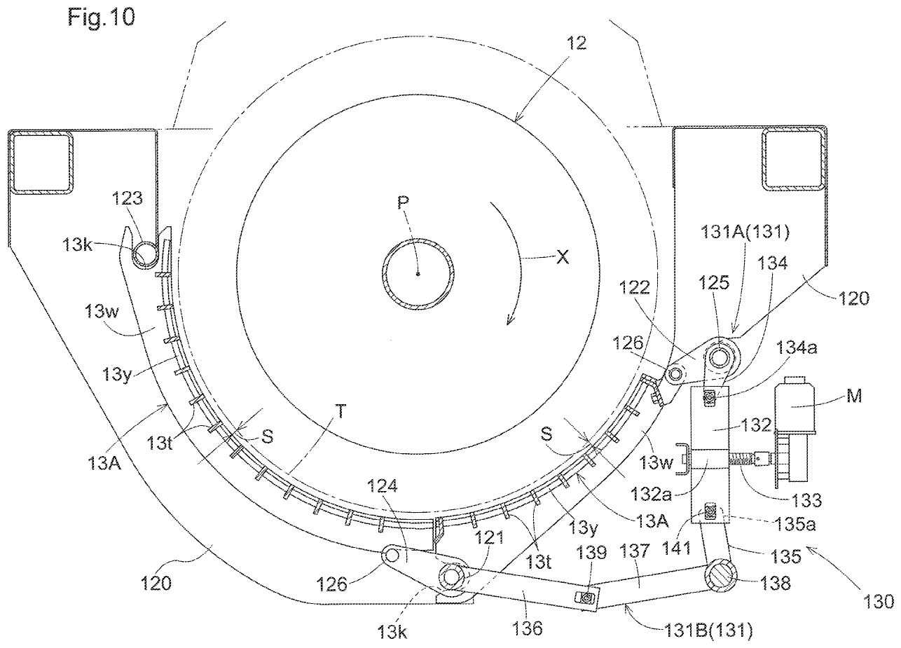

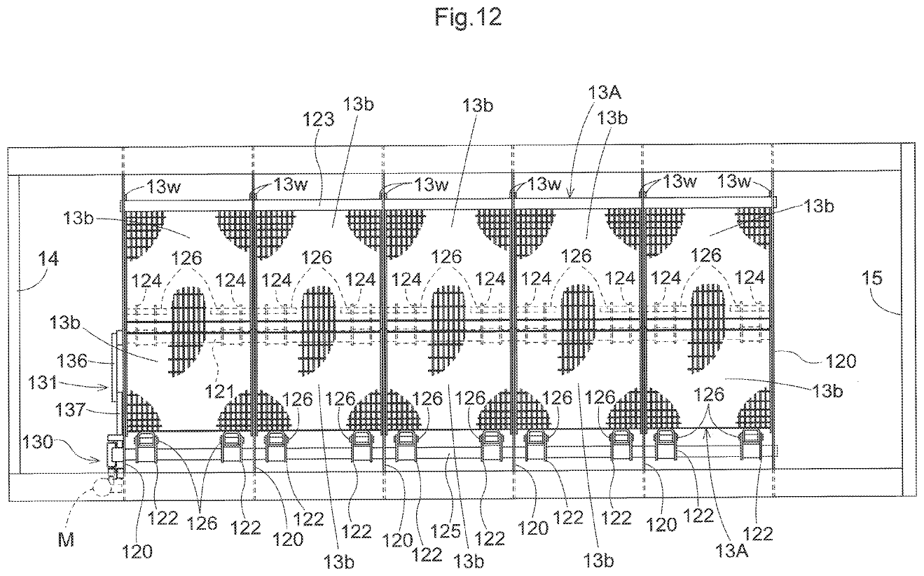

Specifically, in this embodiment, the receiving net 13 is divided into two divided receiving net bodies 13A in the peripheral direction of the threshing drum 12, as shown in FIGS. 10 and 12. One of the two divided receiving net bodies 13A is provided corresponding to the lower left portion of the threshing drum 12. Specifically, one divided receiving net body 13A is provided corresponding to the lower left portion of the first threshing processing section 18F and the second threshing processing section 18R. The other of the two divided receiving net bodies 13A is provided corresponding to the lower right portion of the threshing drum 12. Specifically, the other divided receiving net body 13A is provided corresponding to the lower right portion of the first threshing processing section 18F and the second threshing processing section 18R. As shown in FIGS. 10 and 12, each divided receiving net body 13A includes a receiving net main body having a plurality of vertical bars 13t arranged side by side in the threshing drum peripheral direction and a plurality of horizontal bars 13y arranged side by side in the threshing drum front-rear direction; and a frame portion 13w for retaining the shape of the receiving net main body. The vertical bars 13t are constituted by strip members extending in the threshing drum front-rear direction. The horizontal bars 13y are constituted by bar members formed in an arc shape along the threshing drum peripheral direction.

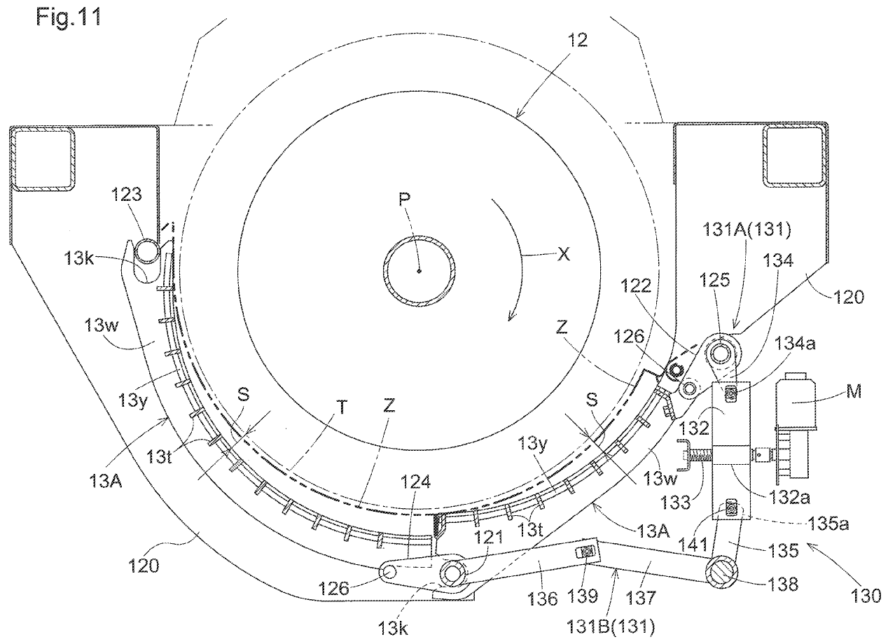

In FIGS. 10 and 11, illustration of the threshing teeth 28 is omitted. T in FIGS. 10 and 11 is the rotation path of the tip of the threshing teeth 28. As shown in FIGS. 10 and 12, of the two divided receiving net bodies 13A, the left divided receiving net body 13A corresponding to the lower left part of the threshing drum 12 has a support shaft 121 that is provided extending in the front-rear direction of the threshing chamber 11 at one end in the threshing drum peripheral direction of the divided receiving net body 13A, and support links 122 that are provided at a plurality of locations in the front-rear direction at the other end in the threshing drum peripheral direction of the divided receiving net body 13A, and the left divided receiving net body 13A is supported by the threshing apparatus 6 via the support shaft 121 and the support links 122. Of the two divided receiving net bodies 13A, the right divided receiving net body 13A corresponding to the lower right part of the threshing drum 12 has a support shaft 123 that is provided extending in the front-rear direction of the threshing chamber 11 at one end in the threshing drum peripheral direction of the divided receiving net body 13A, and support links 124 provided at a plurality of locations in the front-rear direction at the other end in the threshing drum peripheral direction of the divided receiving net body 13A, and the right divided receiving net body 13A is supported by the threshing apparatus 6 via the support shaft 123 and the support link 124. In the present embodiment, the support shafts 121 and 123 of the two divided receiving net bodies 13A are included at ends located downstream in the threshing material movement direction in the divided receiving net bodies 13A, out of both ends in the threshing drum peripheral direction of the divided receiving net bodies 13A. The support links 122 and 124 of the two divided receiving net bodies 13A are provided at ends located upstream in the threshing material movement direction in the divided receiving net bodies 13A, out of both ends of the divided receiving net bodies 13A in the threshing drum peripheral direction.

The support shafts 121 and 123 of the two divided receiving net bodies 13A are provided in notches 13k provided in the frame portions 13w of the divided receiving net bodies 13A and are supported by a plate-shaped threshing frame 120. The threshing frame 120 is supported by the threshing apparatus 6 at a plurality of locations along the front-rear direction of the threshing chamber 11. The support links 122 and 124 of the two divided receiving net bodies 13A are provided in the frame portions 13w of the divided receiving net bodies 13A. The support link 122 of the left divided receiving net body 13A is supported by a support shaft 125 supported by the threshing frame 120 while extending in the threshing chamber front-rear direction. The support link 124 of the right divided receiving net body 13A is supported by the support shaft 121. The support shaft 121 provided in the left divided receiving net body 13A and the support shaft 121 supporting the support link 124 of the right divided receiving net body 13A are a common support shaft. The support link 122 of the left divided receiving net body 13A is supported by the support shaft 125 while being vertically swung around the support shaft 125 serving as a swinging support point due to the rotation of the support shaft 125. The support link 124 of the right divided receiving net body 13A is supported by the support shaft 121 while being vertically swung with the support shaft 121 serving as a swinging support point due to the rotation of the support shaft 121. The support link 122 of the left divided receiving net body 13A and the divided receiving net body 13A are linked by joining the free end of the support link 122 and the frame portion 13w with a joining pin 126 so as to be able to swing relative to each other. The support link 124 of the right divided receiving net body 13A and the divided receiving net body 13A are linked such that the frame portion 13w is received from below by the joining pin 126 provided at the free end of the support link 124. When the support link 124 is swung downward, the right divided receiving net body 13A is swung downward by the weight of the divided receiving net body 13A with the support shaft 123 serving as the swinging support point, and when the support link 124 is swung upward, the right divided receiving net body 13A is swung upward by the pressing performed by the support link 124 with the support shaft 123 serving as the swinging support point.

The support links 122 and 124 at a plurality of locations are swung, whereby the two divided receiving net bodies 13A are swung vertically with the support shafts 121 and 123 provided at the end on the downstream side in the processing material movement direction serving as the swinging support point, and thus the interval S between the divided receiving net body 13A and the threshing drum 12 changes. The interval S between the divided receiving net body 13A and the threshing drum 12 is the interval between the horizontal bars 13y of the divided receiving net body 13A and the rotation path T of the tip of the threshing teeth of the threshing cylinder 12. The change in the interval S between the divided receiving net body 13A and the threshing drum 12 occurs when the interval opposite to the support point of the divided receiving net body 13A (the interval on the upstream side in the threshing material movement direction of the divided receiving net body 13A) changes more than the interval on the support point side of the divided receiving net body 13A (the interval on the downstream side in the threshing material movement direction of the divided receiving net body 13A).

In this embodiment, as shown in FIG. 12, each of the left divided receiving net body 13A and the right divided receiving net body 13A is divided into five divided net receiving constituting bodies 13b in the threshing chamber front-rear direction. The plate-shaped threshing frame 120 is arranged between the adjacent divided receiving net constituting bodies 13b, and each divided receiving net constituting body 13b of the left divided receiving net body 13A swings vertically with respect to the threshing frame 120 with the support shaft 121 serving as a swinging support point, and each of the divided receiving net constituting bodies 13b of the right divided receiving net body 13A swings vertically with respect to the threshing frame 120 with the support shaft 123 serving as the swinging support point. The five divided receiving net constituting bodies 13b of the left divided receiving net body 13A are linked by the support links 122 provided in each of the divided receiving net constituting bodies 13b and the support shaft 125 that links the support links 122 of the respective divided receiving net constituting bodies 13b, and the divided receiving net constituting bodies 13b swing in a linked manner by the same swinging angle in the same swinging direction. The five divided receiving net constituting bodies 13b of the right divided receiving net body 13A are linked by the support links 124 provided in each divided receiving net constituting body 13b and the support shaft 121 linking the support links 124 of the respective divided receiving net constituting bodies 13b, and the divided receiving net constituting bodies 13b swing in a linked manner by the same swinging angle in the same swinging direction. The left divided receiving net body 13A and the right divided receiving net body 13A are substantially one divided receiving net body 13A.

Interval Adjusting Mechanism in Second Embodiment

As shown in FIG. 10, the interval adjusting mechanism 130 is linked to the two divided receiving net bodies 13A, and the interval adjusting mechanism 130 makes it possible to adjust the interval S between the divided receiving net body 13A and the threshing body 12 for every two divided receiving net bodies 13A by operating the two divided receiving net bodies 13A.

As shown in FIG. 10, the interval adjusting mechanism 130 includes an electric motor M serving as a single actuator, and a link mechanism 131 that links the electric motor M to the two divided receiving net bodies 13A.

The link mechanism 131 is joined to the end of each of the two divided receiving net bodies 13A on the side opposite to the support shaft. Specifically, as shown in FIG. 10, the link mechanism 131 includes a parallel link 132 that is linked to the electric motor M and that is operated to move in parallel by the electric motor M, a link mechanism portion 131A for the left that links the parallel link 132 to the end opposite to the support shaft side (the side where the support shaft 121 is located) of the left divided receiving net body 13A, and a link mechanism portion 131B for the right that links the parallel link 132 to the end opposite to the support shaft (the side where the support shaft 123 is located) of the right divided receiving net body 13A.

The link between the electric motor M and the parallel link 132 is achieved by providing the electric motor M with a screw shaft 133 serving as an output shaft capable of forward and reverse rotation, providing the operation section 132a for moving the parallel link 132 at the intermediate portion of the parallel link 132, and inserting the screw shaft 133 in a screw hole provided in the operation section 132a.

As shown in FIG. 10, the left link mechanism portion 131A includes a left operating link 134 that extends from the support shaft 125 toward the parallel link 132 and has an extended end that is engaged with the parallel link 132, and a plurality of support links 122. The left operating link 134 rotates the support shaft 125 and swings the support links 122 at a plurality of locations by being swung with the support shaft 125 serving as a swinging support point.

As shown in FIG. 10, the right link mechanism portion 131B includes a swinging link 135 with a free end 135a engaged with a parallel link 132, a right operating link 136 that swingably extends from the support shaft 121, a joining link 137 that links the free end of the right operating link 136 to the swinging link 135, and support links 124 at a plurality of locations. The swinging link 135 and the joining link 137 are swingably supported by the support point shaft 138. A free end of the right operating link 136 and a free end of the joining link 137 are engaged so as to be able to swing relative to each other. The right operating link 136 swings the support shaft 121 and swings the support links 124 at a plurality of locations due to being swung with the support shaft 121 as a swinging support point.

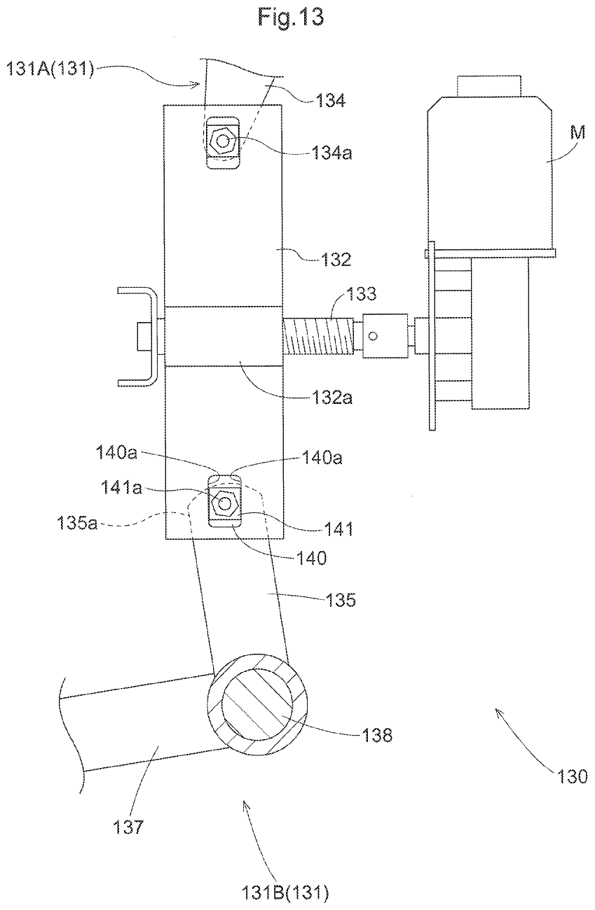

The engagement between the parallel link 132 and the free end 135a of the swinging link 135 is achieved by the parallel link 132 being provided with an elongated groove 140 as shown in FIG. 13, and the link member 141 that is slidably inserted into the elongated groove 140 being supported by the free end 135a. The linking member 141 is rotatably supported by the free end 135a via a joining pin 141a. The linking member 141 is formed in a non-circular shape so as to be non-rotatably inserted in the elongated groove 140. When the parallel link 132 is moved in parallel, the linking member 141 slides in the elongated groove while being in line contact with elongated groove inner walls 140a located on both lateral sides of the linking member 141, transmits the motive power of the parallel link 132 to the swinging link 135 while rotating with respect to the swinging link 135, and enables swinging of the swinging link 135 by the parallel link 132. In this embodiment, the elongated groove 140 is provided in the parallel link 132 and the linking member 141 is provided in the swinging link 135, but a configuration may also be adopted in which the elongated groove 140 is provided in the swinging link 135 and the linking member 141 is provided in the parallel link 132.

The engagement between the parallel link 132 and the left operating link 134 is achieved by an engagement structure having the same configuration as the engagement structure in which the parallel link 132 and the free end 135a of the swinging link 135 are engaged with each other. The engagement of the parallel link 132 and the left operating link 134 is achieved by the elongated groove provided in the parallel link 132, and a non-circular linking member that is slidably and non-rotatably inserted in the elongated groove, and is rotatably supported by the left operating link 134 via the joining pin 134a. The engagement between the free end of the right operating link 136 and the free end of the joining link 137 is achieved by an engagement structure having the same configuration as the engagement structure in which the parallel link 132 and the free end 135a of the swinging link 135 are engaged with each other. The engagement between the free end of the right operating link 136 and the free end of the joining link 137 is achieved by an elongated groove provided in the right operating link 136, and a non-circular linking member that is slidably and non-rotatably inserted in the elongated groove, and is rotatably supported by the joining link 137 via the joining pin 139.

In this embodiment, the electric motor M, the left operating link 134, the parallel link 132, the swinging link 135, the right operating link 136, and the joining link 137 are arranged on the side surface opposite to the receiving net side of the threshing frame 120 located frontmost among the plurality of threshing frames 120, as shown in FIG. 12. The left operating link 134 is joined to the end of the support shaft 125 that protrudes frontward from the frontmost threshing frame 120. The right operating link 136 is joined to the end of the support shaft 121 that protrudes frontward from the frontmost threshing frame 120. There is no limitation to this, and the electric motor M, the left operating link 134, the parallel link 132, the swinging link 135, the right operating link 136, and the joining link 137 may be provided outside the threshing apparatus 6.

FIG. 10 is a front view showing the receiving net 13, the threshing drum 12, and the interval adjusting mechanism 130 with the interval S between the receiving net 13 and the threshing drum 12 adjusted to be narrow. FIG. 11 is a front view showing the receiving net 13, the threshing drum 12, and the interval adjusting mechanism 130 with the interval S between the receiving net 13 and the threshing drum 12 adjusted to be wide. A two-dot chain line Z shown in FIG. 11 indicates the interval S with the width in the adjusted state shown in FIG. 10. As shown in FIGS. 10 and 11, in the interval adjusting mechanism 130, when the electric motor M is driven in forward and reverse rotation directions, the operating portion 132a is pushed or pulled by the rotating screw shaft 133, and the parallel link 132 moves in parallel. Then, the left operating link 134 is swung by the parallel link 132 with the support shaft 125 as the swinging support point, the support shaft 125 is rotated by the left operating link 134, whereby the support links 122 at a plurality of locations are swung by the support shaft 125, and the left divided receiving net body 13A is swung up and down by the support link 122 with the support shaft 121 serving as the swinging support point. As a result, the interval adjusting mechanism 130 adjusts the interval S between the left divided receiving net body 13A and the threshing drum 12. When the parallel link 132 is moved in parallel, the motive power of the parallel link 132 is transmitted to the swinging link 135 by the linking member 141, whereby the swinging link 135 is swung with the support point shaft 138 serving as the swinging support point, the joining link 137 is swung by the swinging link 135 with the support point shaft 138 serving as the swinging support point, whereby the right operating link 136 is swung by the joining link 137 with the support shaft 121 serving as the swinging support point, the support shaft 121 is rotated by the right operating link 136, whereby the support links 124 at a plurality of locations is swung by the support shaft 121, and the right divided receiving net body 13A is swung vertically by the support link 124 with the support shaft 123 as the swinging support point. As a result, the interval adjustment mechanism 130 adjusts the interval S between the right divided receiving net body 13A and the threshing drum 12.

### Other Embodiments of Second Embodiment

(1) An example was described in which the left divided receiving net body 13A and the right divided receiving net body 13A are provided as one divided receiving net body corresponding to the first threshing processing section 18F and the second threshing processing section 18R, but there is no limitation to this. For example, it is preferable that the left divided receiving net body 13A and the right divided receiving net body 13A are divided into the front divided receiving net body section corresponding to the first threshing processing section 18F and the rear divided receiving net body section corresponding to the second threshing processing section 18R in the front-rear direction of the threshing chamber 11.

(2) In the above-described embodiment, an example was described in which the receiving net 13 is divided into two divided receiving net bodies 13A in the peripheral direction of the threshing drum 12, but the receiving net 13 may also be divided into three or more divided receiving net bodies.

(3) In the above-described embodiment, the receiving net 13 constituted by a lattice receiving net is employed, but other than a lattice net, it is possible to employ a crimp net, a resin net, or the like.

(4) In the above-described embodiment, an example was described in which the support shafts 121 and 123, which serve as the swinging support points of the divided receiving net body 13A, are provided on the downstream side in the threshing material movement direction of the divided receiving net body 13A, but the support shafts 121 and 123 may also be provided on the upstream side in the threshing material movement direction of the divided receiving net body 13A.

(5) In the above-described embodiment, an example was shown in which the link mechanism 131 is joined to the end opposite to the support shaft side of the divided receiving net body 13A, but the link mechanism 131 may also be joined to the end on the support shaft side of the divided receiving net body 13A.

(6) In the above-described embodiment, an example was shown in which the threshing drum 12 provided with threshing teeth of different shapes in the threshing processing section 18 is adopted, but a threshing drum in which the shapes of all of the threshing teeth in the threshing processing section 18 are the same may also be employed.

(7) In the above-described embodiment, an example was shown in which the electric motor M is employed, but there is no limitation to this. For example, various actuators such as hydraulic actuators, such as hydraulic cylinders, may be used.

(8) In the above-described embodiment, the combine having the pre-threshing section 8 and the intermediate conveying apparatus 9 was illustrated, but there is no limitation to this. It is also possible to employ a combine in which the reaped grain culms are directly supplied from the feeder 5b to the threshing apparatus 6 without the pre-threshing section 8 and the intermediate conveying apparatus 9.

### Third Embodiment

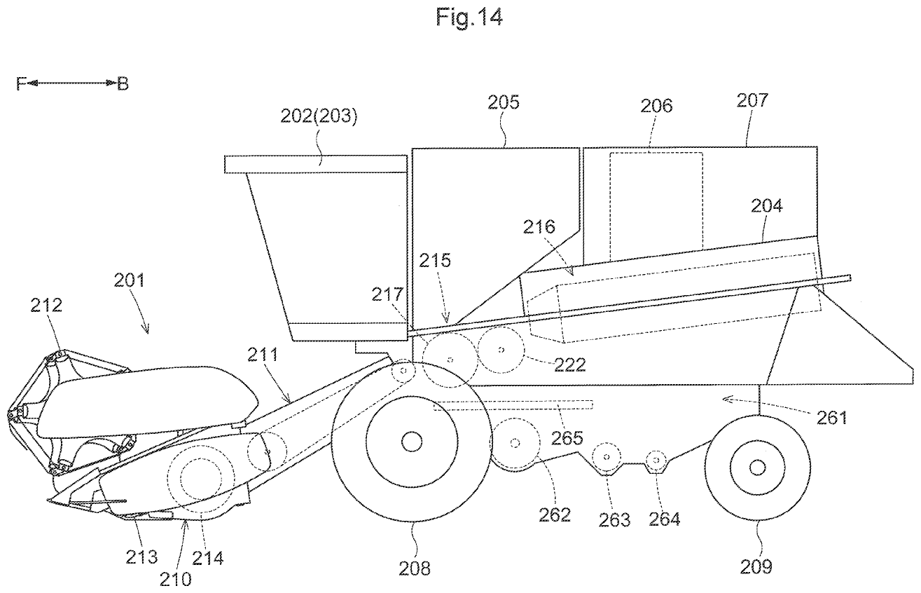

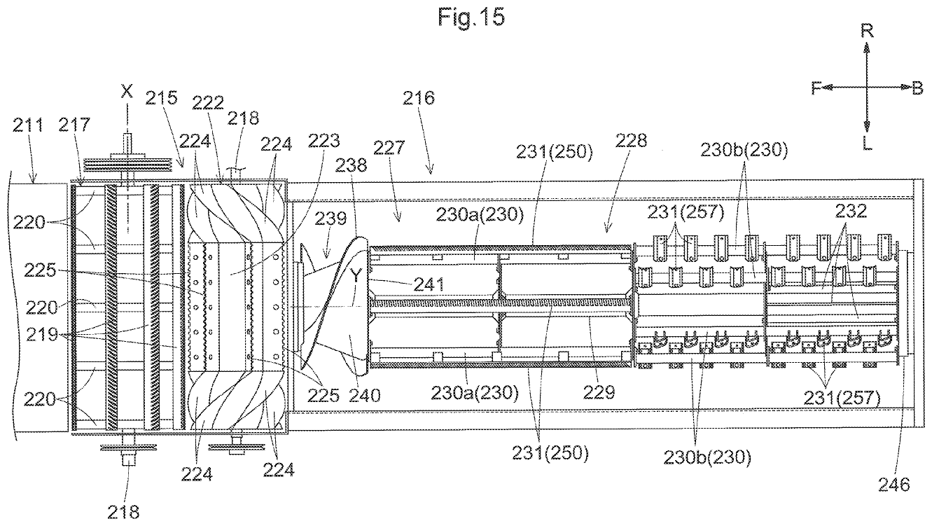

An embodiment (third embodiment) that is an example of the present invention will be described below with reference to the drawings. Here, a case is described where an embodiment of a threshing apparatus according to the present invention is applied to a threshing apparatus for a common combine. In this embodiment, the direction indicated by reference sign (F) is the body front side, and the direction indicated by reference sign (B) is the body rear side (see FIGS. 14, 15, and 16). The direction indicated by reference sign (L) is the body left side, and the direction indicated by reference sign (R) is the body right side (see FIGS. 15, 18, 19 and 20).

Overall Configuration of Combine in Third Embodiment

As shown in FIG. 14, the combine includes a reaping/conveying section 201 that reaps crops and conveys them rearward, a driving section 203 that is covered by a cabin 202, a threshing apparatus 204 that threshes the crops reaped by the reaping/conveying section 201, a grain tank 205 for storing grains obtained by threshing in the threshing apparatus 204, a motor section 207 having an engine 206 serving as a motive power source, left and right front wheels 208, left and right rear wheels 209, and the like.

The reaping/conveying section 201 includes a reaping section 210 serving as a harvesting section that reaps planted crops and gathers the reaped crops in the center in the cutting width direction, and a feeder 211 serving as a crop conveying apparatus that conveys the crops that were reaped and gathered in the center, toward the threshing apparatus 204 in the body rear side. Although not described in detail, the reaping section 210 includes a rotary reel 212 that rakes the ear tip side of the crops to be reaped rearward, a reaping blade 213 that performs reaping by cutting the root base of the crops, a lateral feeding auger 214 that gathers the reaped crops to the center in the reaping width direction, and the like.

A threshing apparatus 204 that receives and threshes the reaped grain culms transported by the feeder 211 as threshing material and sorts the threshing material is provided rearward of the reaping/conveying section 201. A grain tank 205 for collecting and storing single grains conveyed from the threshing apparatus 204 is provided above the front part of the threshing apparatus 204. The motor section 207 is provided above the rear part of the threshing apparatus 204.

Threshing Apparatus in Third Embodiment

Next, the threshing apparatus 204 will be described.

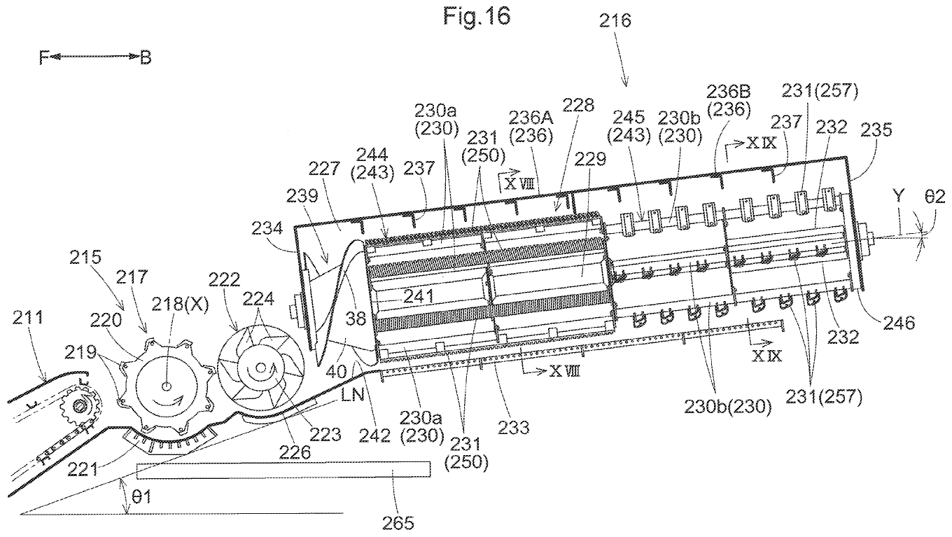

As shown in FIGS. 15 and 16, the threshing apparatus 204 includes a first threshing section 215 where harvested crops are conveyed and threshed, and a second threshing section 216 that is provided rearward of the first threshing section 215, and where the threshing material processed by the first threshing section 215 is introduced and threshed. The first threshing section 215 has substantially the same width in the left-right direction as the feeder 211 and is wider than the second threshing section 216.

First Threshing Section in Third Embodiment

The first threshing section 215 will be described.

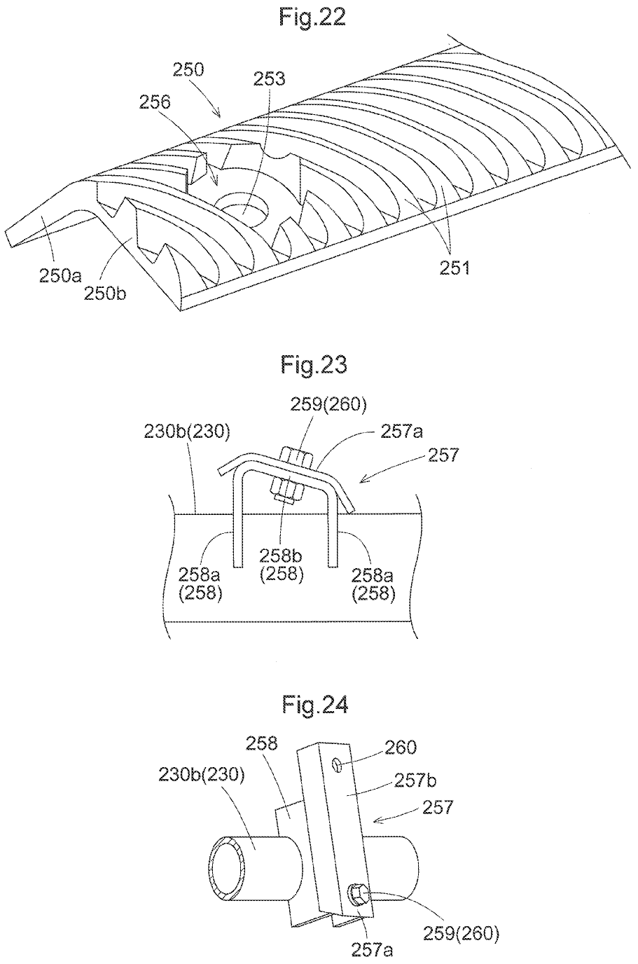

The first threshing section 215 includes a first threshing drum 217 that rotates about a left-right-oriented axis X. The first threshing drum 217 includes a rotary support shaft 218 that extends along the left-right direction and is rotatable, a plurality of rod-shaped threshing teeth 219 that extend in the left-right direction and are spaced apart in the peripheral direction, a plurality of support members 220 that support the plurality of rod-shaped threshing teeth 219 on the rotary support shaft 218 in a state where the radial distance from the rotary support shaft 218 is the same and in a state where they can rotate together. The threshing teeth 219 are formed in a rod shape extending in the left-right direction over the entire width in the left-right direction of the first threshing drum 217, and constituted by rasp threshing teeth (see FIG. 22) that have a surface with recesses and protrusions and thresh the crops with use of the shape of the recesses and protrusions on the surface.

The support members 220 are constituted by plate bodies that are substantially star-shaped in a view from the side, and a plurality thereof are provided at an interval in the left-right direction. The center of the support member 220 is fixed to the rotary support shaft 218 and is supported so as to be integrally rotatable. The threshing teeth 219 are fixed to the plurality of support members 220 by fastening bolts.

A first receiving net 221 is provided in a region below the first threshing drum 217 in the outer peripheral portion of the first threshing drum 217. When the first threshing drum 217 is rotated counterclockwise in FIG. 3 by a driving mechanism (not shown), the crop conveyed by the feeder 211 is raked in by the threshing teeth 219, and threshing is performed due to strokes by the threshing teeth 219, kneading between the threshing teeth 219 and the first receiving net 221, and the like.

An intermediate conveying apparatus 222 that conveys the threshing material threshed in the first threshing section 215 to the second threshing section 216 is provided between the first threshing section 215 and the second threshing section 216. The intermediate conveying apparatus 222 conveys the threshing material toward the second threshing section 216 without leaking downward.

The width in the left-right direction of the intermediate conveying apparatus 222 is the same as the width in the left-right direction of the first threshing section 215. The intermediate conveying apparatus 222 has a configuration similar to that of the lateral feed auger 214, which has a left-right-oriented axis and extends over the entire width in the left-right direction. The intermediate conveying apparatus 222 includes a cylindrical drum 223, spiral blades 224 provided on both left and right sides of the outer periphery of the drum 223, a plurality of raking members 225 provided in the center in the left-right direction of the outer periphery of the drum 223, and a semi-cylindrical bottom plate 226.

The left and right spiral blades 224 are fixed to the outer periphery of the drum 223 and provided in a state in which the feeding directions are opposite to each other. The raking member 225 is fixed to the outer periphery of the drum 223 and is constituted by a plate-shaped member extending radially outward. A plurality of raking members 225 are provided at appropriate intervals in the peripheral direction of the drum 223.

When a driving mechanism (not shown) rotates the drum 223 counterclockwise as shown in FIG. 16, the left and right spiral blades 224 horizontally feed the threshing material so as to gather it in the center in the left-right direction. After being gathered in the center, the threshing material is raked rearward by the raking member 225 and introduced into the second threshing section 216.

The second threshing section 216 includes a threshing chamber 227 for threshing the introduced threshing material. Although the threshing chamber 227 will be described later, the width in the left-right direction of the threshing chamber 227 is narrower than the width in the left-right direction of the intermediate conveying apparatus 222. The left and right spiral blades 224 are provided in regions of the intermediate conveying apparatus 222 that protrude outward on both sides in the left and right direction from both left and right end portions of the threshing chamber 227. Accordingly, the intermediate conveying apparatus 222 gathers the threshing material in the center in the left-right direction, and then can smoothly introduce it into the rearward threshing chamber 227.

As shown in FIG. 16, the lower end position of the intermediate conveying apparatus 222 is located higher than the lower end position of the first threshing section 215. The second threshing section 216 is provided so as to be continuous with the rear end portion of the intermediate conveying apparatus 222.

Second Threshing Section in Third Embodiment

The second threshing section 216 will be described.

As shown in FIGS. 14 and 16, the second threshing section 216 is provided in a rearward rising inclined orientation. The second threshing section 216 includes a threshing chamber 227, and the threshing chamber 227 includes a second threshing drum 228 that rotates about a front-rear-oriented axis Y. The second threshing drum 228 is provided in a rearward-rising inclined orientation, and the axis Y is also in a rearward-rising inclined orientation.

The rearward rising inclination angle θ1 of a virtual line LN connecting the lower end position of the first threshing section 215 and the lower end position of the intermediate conveying apparatus 222 is set larger than the rearward rising inclination angle θ2 of the second threshing section 216. That is, compared to the degree of rearward rising from the first threshing section 215 to the intermediate conveying apparatus 222, the degree of rearward rising of the second threshing section 216 is smaller.

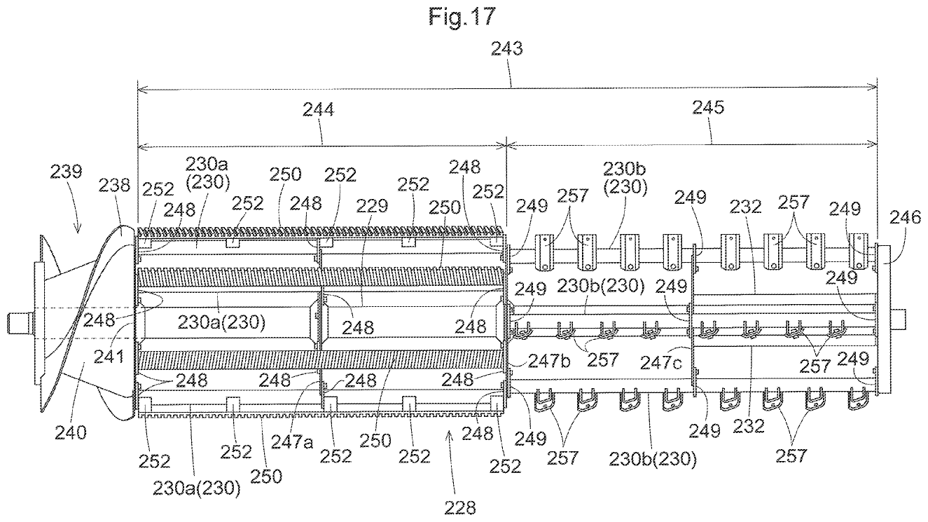

As shown in FIGS. 17 to 20, the second threshing drum 228 includes a rotary support shaft 229 that extends along the front-rear direction and is rotatable, a plurality of rod-shaped frame bodies 230 arranged side by side extending along the front-rear direction and at an interval in a peripheral direction, radially outward of the rotary support shaft 229, and threshing teeth attached to the frame bodies 230. The frame bodies 230 are made of round pipe steel.

The rotary support shaft 229 of the second threshing drum 228 is made of one piece extending from the front end to the rear end of the second threshing drum 228, and is elongated in the front-rear direction. A self-aligning bearing is used as a bearing member that rotatably supports both front and rear sides of the rotary support shaft 229. Although not shown, the second threshing drum 228 is rotationally driven by transmission of motive power to the rear side. When the processing material is clogged or the like and the threshing drum is locked, a force acts on the rear portion of the rotary support shaft 229 in a twisting direction. In view of this, as shown in FIGS. 17 and 19, reinforcing ribs 232 are provided extending radially in a partial region of the rear end of the outer periphery of the rotary support shaft 229.

The second threshing drum 228 is rotationally driven in the clockwise direction (clockwise) in a front view with the rotation support shaft 229 serving as the center of rotation. The lower front portion of the threshing chamber 227 includes an opening that allows the threshing material to be introduced into the threshing chamber 227. A region below the second threshing drum 228 in the surrounding area of the second threshing drum 228 is equipped with a second receiving net 233.

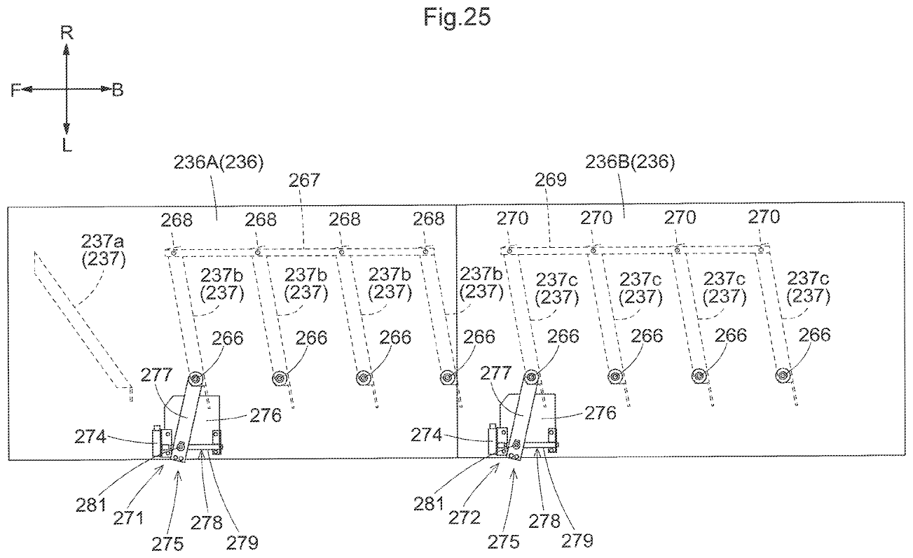

As shown in FIG. 16, the threshing chamber 227 is defined by a front support wall 234 and a rear support wall 235 that support the second threshing drum 228, a top plate 236 provided above the second threshing drum 228, a second receiving net 233, and the like. A plurality of debris transport valves 237 that are arranged side by side in the front-rear direction of the threshing chamber 227 are provided inside the top plate 236. As shown in FIG. 25, the top plate 236 can be divided in the front and rear at a dividing point provided in the center of the threshing chamber 227 in the front-rear direction. Normally, a first top plate 236A located on the front side and a second top plate 236B located on the rear side are bolted together at the division point in the center in the front-rear direction. When it is to be removed for maintenance or the like, the bolt connection is released, the top plate 236 can be divided in the front and rear and taken out rearward.

The front part of the second threshing drum 228 is provided with a raking section 239 having a spiral blade 238. The raking section 239 has a spiral blade 238 integrally fixed to the outer periphery of a tapered drum 240. A front end of the drum 240 is joined to the rotary support shaft 229. A rear end of the drum 240 is joined to a rotary support shaft 229 via a front support member 241. As the rotary support shaft 229 rotates, the raking section 239 rakes the introduced threshing material rearward using the feed action of the spiral blades 238.

As shown in FIG. 16, below the raking section 239, a guide body 242 that receives the threshing material raked in by the raking section 239 and guides the received threshing material rearward without leaking it downward is included. The guide body 242 is constituted by a plate body that is bent in a substantial arc shape in a front view so as to extend along the lower outer periphery of the spiral blade 238. The guide body 242 is provided so as to be continuous with the rear portion of the bottom plate 226 of the intermediate conveying apparatus 222, and smoothly conveys the threshing material conveyed rearward by the raking member 225, rearward without leaking the threshing material downward.

A portion rearward of the raking section 239 of the second threshing drum 228 is provided with a threshing processing section 243.

The threshing processing section 243 includes a first threshing processing section 244 on the front side and a second threshing processing section 245 on the rear side, and the shapes of the threshing teeth of the first threshing processing section 244 and the second threshing processing section 245 are different from each other.

The configuration of the threshing processing section 243 will be described.

As shown in FIG. 17, the threshing processing section 243 includes a front support member 241 joined to a portion of the rotary support shaft 229 corresponding to the rear part of the raking section 239, a rear support member 246 joined to the rear end of the rotary support shaft 229, and three intermediate support members 247a, 247b, and 247c that are joined to the intermediate portion in the front-rear direction of the rotary support shaft 229 at intervals in the axial direction.

The threshing processing section 243 includes a first threshing processing section 244 having six front frame bodies 230a located frontward of the second intermediate support member 247b in the frame body 230, and a second threshing processing section 245 having six rear frame bodies 230b located rearward of the second intermediate support member 247b in the frame body 230.

The front frame bodies 230a and the rear frame bodies 230b are obtained by dividing a single frame body having a front-rear length that spans the front support member 241 and the rear support member 246 in two pieces in the front-rear direction at a position corresponding to the second intermediate support member 247b. The front frame bodies 230a and the rear frame bodies 230b are set to have the same length.

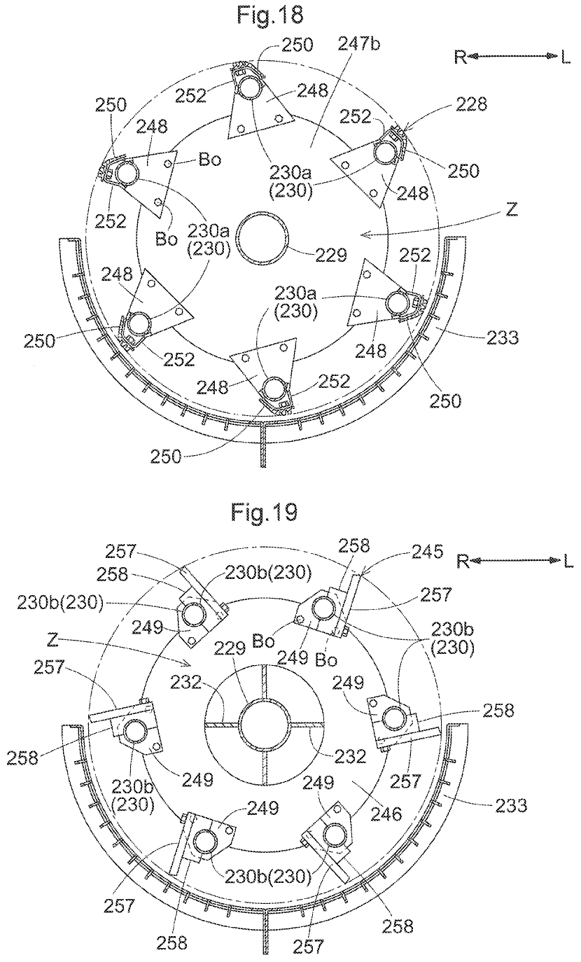

As shown in FIG. 18, the six front frame bodies 230a are arranged side by side in the peripheral direction of the second threshing drum 228 at regular intervals. A plate-shaped joining member 248 is joined by welding to the front end of each front frame body 230a, and the joining member 248 is joined to the front supporting member 241 with bolts Bo. Similarly to the front end, the rear end of the front frame body 230a is joined by welding to a plate-shaped connecting member 248, and the joining member 248 is joined to the second intermediate support member 247b with bolts Bo.

As shown in FIG. 19, the six rear frame bodies 230b are arranged side by side in the peripheral direction of the second threshing drum 228 at regular intervals. A plate-shaped joining member 249 similar to the front frame body 230a is joined by welding to the front end portion of each rear frame body 230b, and the joining member 249 is joined to the second intermediate support member 247b with bolts Bo. Similarly to the front end, the rear end of the rear frame body 230b is joined to the rear support member 246 via a plate-shaped joining member 249 with bolts Bo.

As described above, the front frame bodies 230a and the rear frame bodies 230b have the same length and the same attachment structure. Accordingly, the front frame bodies 230a can be attached also to the second threshing processing section 245, and the rear frame bodies 230b can be attached also to the first threshing processing section 244. That is, it is possible to replace them by disconnecting the bolts Bo and changing the front-rear position.

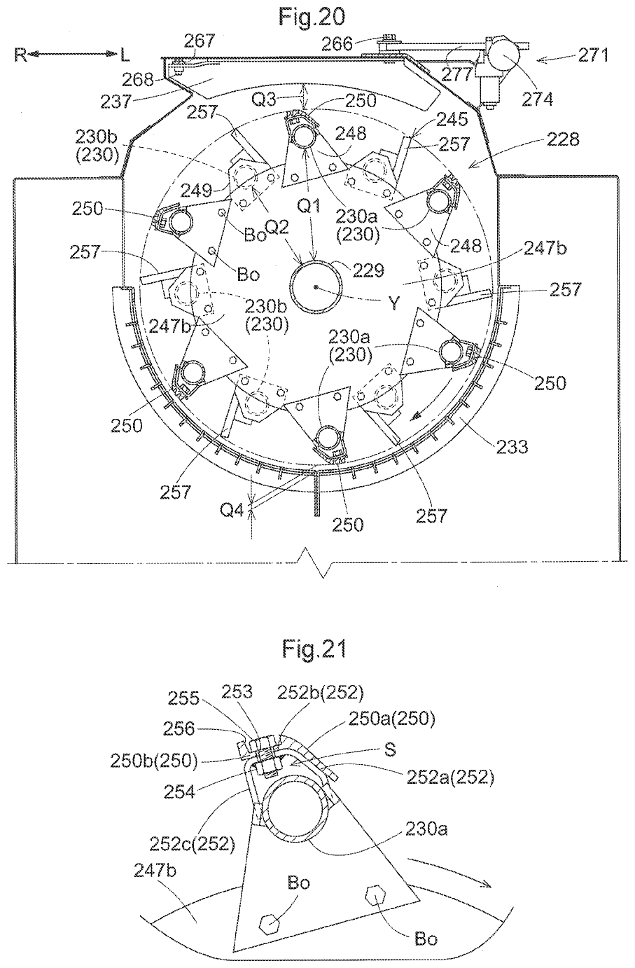

An interval Q1 in the radial direction between the front frame body 230a and the rotary support shaft 229 and an interval Q2 in the radial direction between the rear frame body 230b and the rotary support shaft 229 are different from each other. To add description, as shown in FIG. 20, the front frame body 230a is arranged radially outward relative to the rear frame body 230b. Accordingly, the interval Q1 in the radial direction between the front frame body 230a and the rotary support shaft 229 is larger than the interval Q2 in the radial direction between the rear frame body 230b and the rotary support shaft 229.

Both the front frame bodies 230a and the rear frame bodies 230b are arranged in a distributed manner at equal intervals in the peripheral direction, and the front frame bodies 230a and the rear frame bodies 230b are arranged in different phases in the peripheral direction. Specifically, the front frame bodies 230a and the rear frame bodies 230b are arranged with their phases shifted in the peripheral direction such that the rear frame bodies 230b are each located at a substantially intermediate position in the peripheral direction between the two adjacent front frame bodies 230a.

By arranging in this way, the joining member 248 on the front frame body 230a side and the joining member 249 on the rear frame body 230b side can be displaced in the peripheral direction, and the task of joining to the second intermediate support member 247b can be performed easily.

The first threshing processing section 244 is provided with first threshing teeth 250 that have recesses and protrusions on the surface and thresh crops with use of the shape of the recesses and protrusions on the surface. The first threshing teeth 250 also have the same configuration as the threshing teeth 219 provided on the first threshing drum 217. That is, as shown in FIG. 22, the first threshing teeth 250 are composed of rasp threshing teeth that have a large number of recesses and protrusions 251 formed on the surface and thresh crops with use of the shape of the recesses and protrusions on the surface.

As shown in FIGS. 18 and 21, a rotation direction upstream portion 250a of the first threshing teeth 250 is formed with a smooth outer peripheral surface, and is provided in an inclined shape such that the interval between the rotation direction upstream portion 250a and the second receiving net 233 in the radial direction becomes narrower toward the downstream side in the rotation direction. A rotation direction downstream portion 250b of the first threshing teeth 250 has an outer peripheral surface on which recesses and protrusions 251 are formed, and the interval between the rotation direction downstream portion 250b and the second receiving net 233 along the radial direction is approximately the same over the entire width in the peripheral direction.

The first threshing teeth 250 are shaped like rods extending along the longitudinal direction of the front frame body 230a. The first threshing teeth 250 are supported by a support base 252 attached to the front frame body 230a. A plurality of support bases 252 (five in the example shown in FIG. 17) are attached to the front frame body 230a at intervals along the axial direction of the second threshing drum 228.

As shown in FIG. 21, the support base 252 is constituted by a plate body that is bent into a substantial U shape in a view in the direction of the rotation axis, and both ends are joined by welding to the outer peripheral surface of the front frame body 230a. Also, the support base 252 includes an upstream support portion 252a that has one end welded to the outer peripheral surface of the front frame body 230a and supports the rotation direction upstream portion 250a of the first threshing teeth 250, a downstream support portion 252b that is continuous with the upstream support portion 252a and supports the rotation direction downstream portion 250b of the first threshing teeth 250, and an extended portion 252c that is continuous with the downstream support portion 252b and has another end welded to the outer peripheral surface of the front frame body 230a. The upstream support portion 252a is provided in a shape extending along the rotation direction upstream portion 250a of the first threshing teeth 250, and the downstream support portion 252b is provided in a shape extending along the rotation direction downstream portion 250b of the first threshing teeth 250. A gap S is formed between the downstream support portion 252b and the front frame body 230a.

The first threshing teeth 250 are detachably supported on the support base 252. As shown in FIGS. 21 and 22, a bolt hole 253 is formed at a position corresponding to the support base 252 in the rotation direction downstream portion 250b of the first threshing teeth 250. The inner surface of the portion of the downstream support portion 252b corresponding to the bolt hole 253 includes a welded nut 254. A bolt 255 and a nut 254 mounted from the outer peripheral side fasten and fix the rotation direction downstream portion 250b of the first threshing teeth 250 and the downstream support portion 252b of the support base 252. A recess 256 into which the bolt head is inserted is formed on the outer peripheral side of the rotation direction downstream portion 250b of the first threshing teeth 250. This prevents the head of the bolt 255 from protruding radially outward.

The second threshing processing section 245 includes second threshing teeth 257 extending radially outward in a rod shape. As shown in FIG. 23, the second threshing teeth 257 are constituted by a plate body having a substantially U-shaped cross section, and are provided in a longitudinally elongated shape along the radial direction. The second threshing teeth 257 are joined and supported by fastening a bolt 259 to a bracket 258 fixed to the outer peripheral portion of the rear frame body 230b. The bracket 258 is constituted by a plate body having a substantially U-shaped cross section, and both side faces 258a of the bracket 258 are welded to the outer periphery of the rear frame body 230b. The brackets 258 are provided at appropriate intervals in the longitudinal direction of the rear frame body 230b. An intermediate portion 258b between the side faces 258a on both sides of the bracket 258 is formed in a planar shape, and is formed in an inclined orientation in which the rear portion is located on the downstream side in the rotation direction.

The second threshing teeth 257 are fixed to the bracket 258 by tightening a bolt 259 while abutting on the intermediate portion 258b of the bracket 258 from the outside. The intermediate portion 257a of the second threshing teeth 257 is formed in a planar shape, and the outer surface of the intermediate portion 257a forms a threshing surface 257b that acts on crops. The fixing portion of the second threshing teeth 257 to the bracket 258, specifically, the formation locations of the insertion holes 260 through which the bolts 259 are inserted, are formed at two locations equidistant from the center in the longitudinal direction.

By being configured in this way, when the radial outer end of the second threshing teeth 257 is worn due to long-term threshing, the direction of the second threshing teeth 257 can be reversed in the longitudinal direction and can be fixed by a bolt in the other insertion hole 260.

As shown in FIG. 19, the second threshing teeth 257 are inclined so as to be located on the downstream side in the rotation direction of the second threshing drum 228 toward the outside in the radial direction in a view in the axial direction of the rotary support shaft 229. In addition, the intermediate portion 258b of the bracket 258 to which the second threshing teeth 257 are attached is formed in an inclined orientation of being located on the downstream side in the rotation direction toward the rear.

Accordingly, the threshing surface 257b of the second threshing teeth 257 is formed in an inclined orientation of being located on the downstream side in the rotation direction toward the rear, and is inclined so as to be located on the downstream side in the rotation direction of the second threshing drum 228 toward the outside in the radial direction in a view in the axial direction of the rotary support shaft 229.

As shown in FIG. 20, in a view in the axial direction of the rotary support shaft 229, the path of the outer end of the second threshing drum 228 in the first threshing processing section 244, that is, the movement path of the radial outer end of the first threshing teeth 250, and the path of the outer end of the second threshing drum 228 in the second threshing processing section 245, that is, the movement path of the radial outer end of the second threshing teeth 257, are at the same position.

The second threshing drum 228 is formed in a basket shape with an internal space Z that is in communication with the outer peripheral space through the space between the front frame bodies 230a and the space between the rear frame bodies 230b. Accordingly, the second threshing drum 228 allows the processing material to enter the internal space Z during threshing, whereby it is possible to avoid an excessive drive load due to the second threshing drum 228.

As shown in FIG. 14, below the first threshing section 215 and the second threshing section 216, a sorting section 261 serving as a sorting apparatus that sorts the threshing material leaked from the first receiving net 221 and threshing material leaked from the second receiving net 233 into grains, grains with branches (secondary products), other stalk waste, debris, and the like while swinging and transferring the threshing material. The sorting section 261 includes a sorting fan 262 that supplies sorting air, a grain recovery section 263 that recovers grains, and a secondary product recovery section 264 that recovers secondary products and returns them to the threshing chamber 227.

The sorting section 261 includes a grain pan 265 extending from the region below the first threshing section 215 to the region below the second threshing section 216. The rear end of the grain pan 265 extends to a position below the front end of second receiving net 233.

The grain pan 265 can transfer the threshing material that has leaked down from the first receiving net 221 of the first threshing section 215 to the region below the second threshing section 216 as-is. As a result, the sorting can be efficiently performed together with the threshing material leaked from the second receiving net 233 of the second threshing section 216.

Debris Transport Valves in Third Embodiment

Next, the debris transport valves 237 will be described.

As shown in FIG. 25, a front end debris transport valve 237a located frontmost among the plurality of debris transport valves 237 is provided above the raking section 239 in the second threshing drum 228. The feed angle of the front end debris transport valve 237a is fixed. Accordingly, the front end debris transport valve 237a corresponds to a fixed debris transport valve.

Of the plurality of debris transport valves 237 attached to the top plate 236, the plurality of debris transport valves 237 other than the front end debris transport valve 237a are attached in such a manner that the feed angle can be changed. Among the plurality of debris transport valves 237, the respective feed angles of a plurality of front debris transport valves 237b (four in the example shown in FIG. 25) that are located frontward and a plurality of rear debris transport valves 237c (four in the example shown in FIG. 25) that are located rearward can be simultaneously changed separately.

The plurality of front debris transport valves 237b are provided on the top plate 236 at positions corresponding to the first threshing processing section 244, and the plurality of rear debris transport valves 237c are provided on the top plate 236 at positions corresponding to the second threshing processing section 245. That is, the plurality of front debris transport valves 237b are provided on the first top plate 236A, and the plurality of rear debris transport valves 237c are provided on the second top plate 236B. Among the plurality of front debris transport valves 237b, the front debris transport valve 237b located at the rear end can be switched to enter the region below the second top plate 236B.

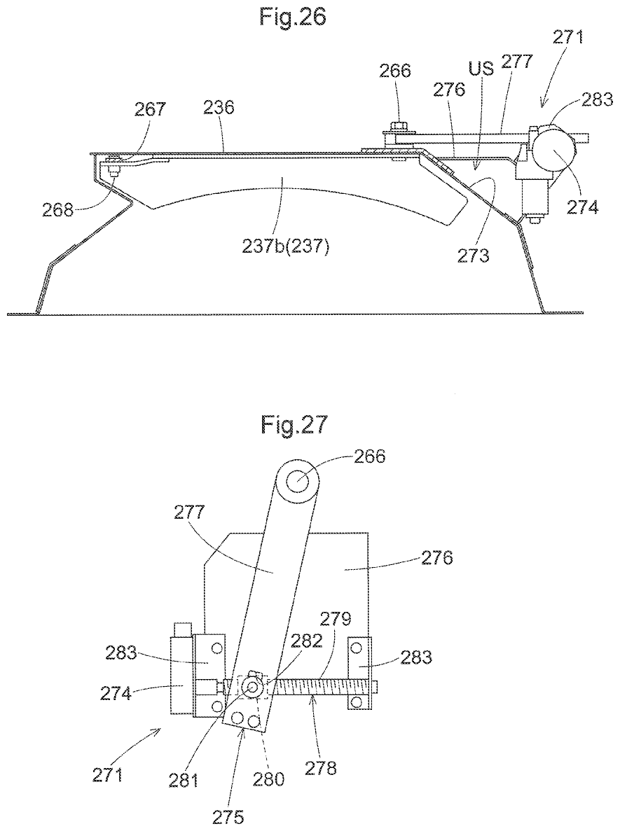

As shown in FIGS. 25 and 26, the plurality of front debris transport valves 237b and the plurality of rear debris transport valves 237c are located on the inner surface side of the top plate 236 and swingably supported via swinging support point shafts 266. The swinging support point shafts 266 are provided on the left sides of the front debris transport valves 237b and the rear debris transport valves 237c. An interlocking link 267 is joined via a joining pin 268 to the right free end of each of the plurality of front debris feeding valves 237b. That is, the plurality of front debris transport valves 237b are joined by the interlocking link 267 so as to swing in a linked manner in the same swinging direction.

Also, an interlocking link 269 is joined via a joining pin 270 to the right free end of each of the plurality of rear debris transport valves 237c. That is, the plurality of rear debris transport valves 237c are linked by the interlocking link 269 so as to swing in a linked manner in the same swinging direction.

A first angle adjusting mechanism 271 capable of simultaneously changing the feed angles of the plurality of front debris transport valves 237b, and a second angle adjusting mechanism 272 capable of simultaneously changing the feed angles of the plurality of rear debris transport valves 237c are provided.

As shown in FIG. 26, an inclined surface portion 273 in a downward inclined orientation in which the rearward side is located downward is formed at the left end of the top plate 236. The first angle adjusting mechanism 271 and the second angle adjusting mechanism 272 are arranged in an upper space US having a triangular cross section, which is formed directly above the inclined surface portion 273.

Since the first angle adjusting mechanism 271 and the second angle adjusting mechanism 272 have the same configuration, the configuration of the first angle adjusting mechanism 271 will be described below, and the description of the second angle adjusting mechanism 272 will be omitted.

The first angle adjusting mechanism 271 includes an electric motor 274 serving as a driving motor and a link mechanism 275 that joins the electric motor 274 and the front debris transport valve 237b to each other. The electric motor 274 is supported by a support base 276 fixed to the top plate 236.

The link mechanism 275 includes an adjustment lever 277 extending laterally outward from a swinging support point shaft 266 of one of the plurality of front debris transport valves 237b, and an operation mechanism 278 for swinging the lever 277 back and forth with use of the driving of the electric motor 274. The operating mechanism 278 includes a screw shaft 279 that is rotationally driven by the electric motor 274, and a female screw member 280 that moves in the front-rear direction as the screw shaft 279 rotates, and an operation pin 281 provided facing upward on the female screw member 280 is engaged through an elongated insertion hole 282 formed in the adjustment lever 277.

The screw shaft 279 extends in the body front-rear direction and is rotatably supported by front and rear support brackets 283 fixed to the support base 276. The electric motor 274 is supported by a support bracket 283 on the front side.

When the screw shaft 279 is rotated by the driving of the electric motor 274, the female screw member 280 moves back and forth along with it, and the adjustment lever 277 swings back and forth. Then, the plurality of front debris transport valves 237b are swung by the interlocking link 267. That is, it is possible to adjust the feed angles of the plurality of front debris transport valves 237b.

As shown in FIG. 20, an interval Q3 in the radial direction between the movement path of the radial outer end of the second threshing drum 228 and the radial inner end of the debris transport valve 237 is greater than an interval Q4 in the radial direction between the movement path of the radial outer end of the second threshing drum 228 and the radial inner end of the second receiving net 233. In this manner, the drive load on the second threshing drum 228 can be minimized while favorably performing threshing.

### Other Embodiments of Third Embodiment

(1) In the above-described embodiment, the second threshing drum 228 includes the first threshing processing section 244 and the second threshing processing section 245, the plurality of front debris transport valves 237b are provided at positions corresponding to the first threshing processing section 244, and the plurality of rear debris transport valves 237c are provided at positions corresponding to the second threshing processing section 245. However, instead of this configuration, a configuration in which a plurality of front debris transport valves 237b are provided in the front region and a plurality of rear debris transport valves 237c are provided in the rear region may also be used as the configuration in which the second threshing drum 228 includes threshing processing sections with the same configuration over the entire region.

(2) In the above-described embodiment, the first angle adjusting mechanism 271 and the second angle adjusting mechanism 272 are arranged in the upper space US having a triangular cross-sectional shape, which is formed directly above the inclined surface portion 273 of the top plate 236. However, instead of this configuration, it is also possible to use a configuration in which the first angle adjusting mechanism 271 and the second angle adjusting mechanism 272 are provided above the upper surface of the top plate 236, and the installation state can be changed in various ways.

(3) In the above-described embodiment, the top plate 236 is divided into the first top plate 236a and the second top plate 236b. However, instead of this configuration, there may be a single top plate 236 over the entire region.

(4) In the above-described embodiment, the fixed debris transport valve 237a is provided above the raking section 239. However, instead of this configuration, it is also possible to use a configuration including a debris transport valve with a feed angle that can be changed, above the raking section 239.

(5) In the above-described embodiment, the first angle adjusting mechanism 271 and the second angle adjusting mechanism 272 include the electric motor 274 as the driving motor, and the link mechanism 275 including the adjustment lever 277 and the screw-feeding operation mechanism 278 is used. However, instead of this configuration, it is also possible to use a configuration in which a hydraulic motor is included as the driving motor, or the rotation of the driving motor is transmitted to the swinging support point shaft 266 via a deceleration gear mechanism. Also, it is possible to use a configuration in which the feed angle is manually adjusted without using a drive motor, and various configurations can be used as the first angle adjusting mechanism 271 and the second angle adjusting mechanism 272.

(6) In the above embodiment, the interval Q3 in the radial distance between the movement path of the radial outer end of the threshing drum 228 and the radial inner end of the debris transport valve 237 is greater than the interval Q4 in the radial direction between the movement path of the radial outer end of the threshing drum 228 and the radial inner end of the receiving net. However, instead of this configuration, it is also possible to use a configuration in which the intervals Q3 and Q4 are the same, a configuration in which the interval Q3 is smaller than the interval Q4, and the like.

### Fourth Embodiment

An embodiment (fourth embodiment), which is an example of the present invention, will be described below with reference to the drawings.

In this embodiment, the configuration of the second receiving net 233 is different from that of the third embodiment, but other configurations are the same as those of the third embodiment. Only the differences from the third embodiment will be described below, and descriptions of the same configurations will be omitted.

Second Receiving Net in Fourth Embodiment

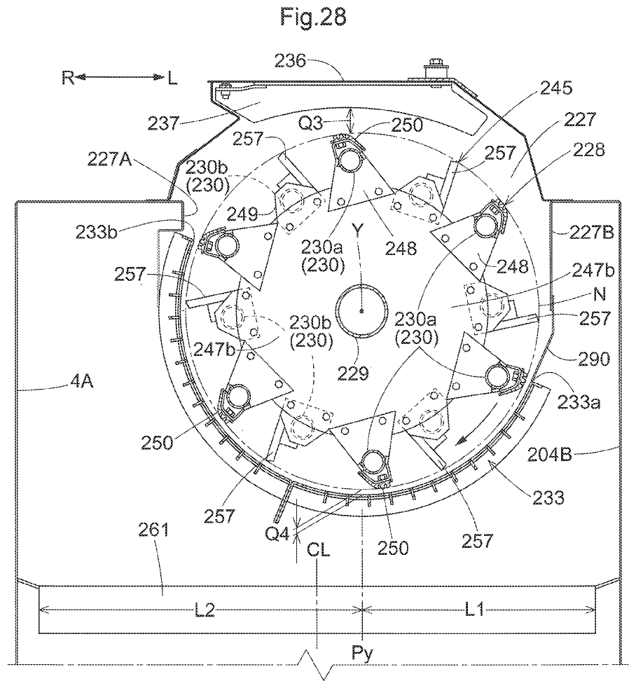

The second receiving net 233 is a receiving net having a known configuration formed by joining a plurality of arc-shaped horizontal bars and a plurality of vertical bars in a lattice pattern. Also, as shown in FIG. 28, an upstream end 233a of the second receiving net 233 located on the upstream side in the rotation direction of the second threshing drum 228 is located at a position lower than the rotation axis Y of the second threshing drum 228, a side wall portion 290 is provided on the upstream side in the rotation direction relative to the upstream end 233a of the second receiving net 233 in the threshing chamber 227, and a downstream end 233b of the second receiving net 233 located on the downstream side in the rotation direction of the second threshing drum 228 is located at a position higher than the rotation axis Y of the second threshing drum 228.

The upstream end 233a of the second receiving net 233 is located inward in the left-right direction with respect to a movement path outer end position N that is located on an outermost side in the left-right direction of a movement path of a radial outer end of the second threshing drum 228 and is close to the upstream end 233a. With this configuration, the upstream end 233a of the second receiving net 233 is provided at a position sufficiently lower than the rotation axis Y of the second threshing drum 228.

The side wall portion 290 is provided in a state of being continuous in a substantial arc shape along the second receiving net 233. A left wall portion 227A of the threshing chamber 227 is provided on the upstream side in the rotation direction of the second threshing drum 228 relative to the side wall portion 290. A right wall portion 227B of the threshing chamber 227 is provided on the downstream side in the rotation direction of the second threshing drum 228 relative to the downstream end 233b of the second receiving net 233. In this way, the second threshing drum 228 prevents the threshing material from leaking out as it is moved around.

As shown in FIG. 28, the sorting section 261 is located below the second receiving net 233, and the sorting section 261 is provided in a wide area over left and right side walls 204A and 204B of the threshing apparatus 204 such that the threshing material does not leak downward. The sorting section 261 is arranged shifted to the left with respect to the second threshing drum 228 in a view in the direction of the rotation axis of the second threshing drum 228.

That is, the sorting section 261 is arranged biased such that the center position CL in the left-right direction of the sorting section 261 is a position biased toward the downstream end of the second receiving net 233, that is, to the right side, with respect to the rotation axis Y of the second threshing drum 228. In other words, the sorting section 261 has a narrow range L1 from the position Py corresponding to the rotation axis Y of the second threshing drum 228 to the left end, and a wide range L2 from a position Py corresponding to the rotation axis Y of the second threshing drum 228 to the right end.

With this configuration, the amount of the threshing material leaked from the second receiving net 233 is reduced at the left end of the sorting section 261 on the second receiving net 233. On the other hand, on the right side, the amount of processing material increases overall by an amount corresponding to the amount by which the second receiving net 233 is extended to the right side and the leakage area is widened, but the variation is reduced by widening the receiving width on the right side of the sorting section 261 and reducing the processing amount per unit width in the left-right direction.

### Other Embodiments of Fourth Embodiment

(1) In the above-described embodiment, the upstream end 233a of the second receiving net 233 is located on the right side with respect to the movement path outer end position N. However, the upstream end 233a of the second receiving net 233 may be located on the left side with respect to the movement path outer end position N, and the upstream end 233a of the second receiving net 233 may be located at the same position as the movement path outer end position N.

(2) In the above-described embodiment, the sorting section 261 is arranged biased such that the center position CL of the sorting section 261 in the left-right direction is biased toward the downstream end (right side) of the second receiving net 233 with respect to the rotation axis Y of the second threshing drum 228, but instead of this configuration, the center position CL in the left-right direction of the sorting section 261 may be arranged biased with respect to the rotation axis Y of the second threshing drum 228, and the center position CL in the left-right direction of the sorting section 261 may be arranged at the same position as the rotation axis Y of the second threshing drum 228.

(3) In the above embodiment, the second threshing drum 228 includes the first threshing processing section 244 on the front side and the second threshing processing section 245 on the rear side, which have different threshing teeth. However, instead of this configuration, the second threshing drum 228 may have one threshing processing section having the same threshing teeth. Also, the configuration of the threshing teeth is not limited to rasp threshing teeth and rod- shaped threshing teeth, and various types of threshing teeth can be used.

### INDUSTRIAL APPLICABILITY

The present invention is applicable not only to combines for harvesting rice, wheat, buckwheat, and the like, but also to various harvesters for harvesting corn.

Moreover, the present invention can be applied to a threshing apparatus for threshing harvested crops.

### DESCRIPTION OF REFERENCE SIGNS

First Embodiment
5a Harvesting section
6 Threshing apparatus
11 Threshing chamber
12 Threshing drum
13 Receiving net
13A Divided receiving net body
14 Front wall
15 Rear wall
20 Support shaft
30 Interval adjusting mechanism
40 Interval adjusting mechanism
41 Link mechanism
M1 First electric motor
M2 Second electric motor
M3 Actuator (third electric motor)

Second Embodiment
121 Support shaft
123 Support shaft
131 Link mechanism
132 Parallel link
135 Swinging link
140 Elongated groove
141 Linking member
P Threshing drum axis
M Actuator (electric motor)

Third Embodiment
227 Threshing chamber
228 Threshing drum
236 Top plate
237 Debris transport valve
237a Front debris transport valve
237b Rear debris transport valve
238 Spiral blade
239 Raking section
244 First threshing processing section
245 Second threshing processing section
271 First angle adjusting mechanism
272 Second angle adjusting mechanism
273 Inclined surface portion
274 Electric motor (driving motor)
275 Link mechanism
US Upper space
Q3, Q4 Interval

Fourth Embodiment
233 Receiving net
233a Upstream end
233b Downstream end
261 Sorting section (sorting apparatus)
290 Side wall portion
CL Center position
N Movement path outer end position
Y Rotation axis

1. A harvester comprising:
a harvesting section configured to harvest a crop in a field; and
a threshing apparatus into which the crop harvested by the harvesting section is introduced and which is configured to thresh the introduced crop,
wherein the threshing apparatus comprises:
a threshing chamber into which the crop is introduced,
a threshing drum provided in the threshing chamber in such a manner as to rotate with a threshing drum axis extending in a front-rear direction of the threshing chamber serving as a rotation center, and configured to thresh the crop introduced into the threshing chamber, and
a receiving net provided in an outer periphery of a lower part of the threshing drum,
wherein the receiving net is divided into a plurality of divided receiving net bodies in the front-rear direction, and
wherein the plurality of divided receiving net bodies are operated to adjust, for each of the plurality of divided receiving net bodies, an interval in a radial direction of the threshing drum between the divided receiving net body and the threshing drum.

2. The harvester according to claim 1, further comprising:
an interval adjusting mechanism separately joined to each of the plurality of divided receiving net bodies and configured to adjust the interval in the divided receiving net body.

3. The harvester according to claim 2,
wherein the divided receiving net body comprises a support shaft provided extending in the front-rear direction on one end in a peripheral direction of the threshing drum of the divided receiving net body, and the divided receiving net body is supported in such a manner as to be swingable vertically with the support shaft serving as a swinging support point, and
wherein the interval adjusting mechanism is joined to another end in the peripheral direction of the threshing drum of the divided receiving net body, and adjusts the interval of the divided receiving net body by swinging the divided receiving net body vertically.

4. The harvester according to claim 2, wherein:
the plurality of divided receiving net bodies are a front divided receiving net body and a rear divided receiving net body obtained by dividing the receiving net into two in the front-rear direction,
the interval adjusting mechanism configured to adjust the interval of the front divided receiving net body comprises a first electric motor configured to operate the interval adjusting mechanism,
the interval adjusting mechanism configured to adjust the interval of the rear divided receiving net body comprises a second electric motor configured to operate the interval adjusting mechanism,
the first electric motor is provided outside of a front wall of the threshing chamber, and
the second electric motor is provided outside of a rear wall of the threshing chamber.

5. The harvester according to claim 1, further comprising:
an actuator configured to adjust the intervals of the plurality of divided receiving net bodies; and
a link mechanism linking the actuator and the plurality of divided receiving net bodies,
wherein the link mechanism transmits motive power with different link ratios to the plurality of divided receiving net bodies in such a manner that adjustment allowances of the intervals of the plurality of divided receiving net bodies adjusted by the actuator are different for the plurality of divided receiving net bodies.

6. A threshing apparatus comprising:
a threshing chamber;
a threshing drum rotatably provided in the threshing chamber and configured to perform threshing of a crop introduced into a front part of the threshing chamber;
a top plate covering an upper portion of the threshing chamber; and
a plurality of debris transport valves that are supported on the top plate, arranged side by side along a rotation axis of the threshing drum, and configured to feed and guide a threshing material toward a rear part of the threshing chamber,
wherein the plurality of debris transport valves are attached with changeable feed angles, and
the threshing apparatus further comprises:
a first angle adjusting mechanism capable of simultaneously changing feed angles of a plurality of front debris transport valves located frontward among the plurality of debris transport valves; and
a second angle adjusting mechanism capable of simultaneously changing feed angles of a plurality of rear debris transport valves located rearward among the plurality of debris transport valves.

7. The threshing apparatus according to claim 6,
wherein the threshing drum comprises:
a first threshing processing section located at a front part, and
a second threshing processing section, which is located at a rear part and has a different structure from the first threshing processing section,
wherein the plurality of front debris transport valves are provided on the top plate at a position corresponding to the first threshing processing section, and
wherein the plurality of rear debris transport valves are provided on the top plate at a position corresponding to the second threshing processing section.

8. The threshing apparatus according to claim 6,
wherein each of the first angle adjusting mechanism and the second angle adjusting mechanism comprises a driving motor and a link mechanism that joins the driving motor and the debris feeding valves,
wherein an inclined surface portion in a downward inclined orientation in which an outer side is located downward is formed at one end of the top plate in a left-right direction, and
wherein the first angle adjusting mechanism and the second angle adjusting mechanism are disposed in an upper space having a triangular cross-sectional shape, which is formed directly above the inclined surface portion.

9. The threshing apparatus according to claim 6,
wherein the top plate is divided into a first top plate provided with the plurality of front debris transport valves and a second top plate provided with the plurality of rear debris transport valves, and
wherein a front debris transport valve located at a rear end among the plurality of front debris transport valves is configured to be switched to enter a region below the second top plate.

10. The threshing apparatus according to claim 6, further comprising:
a raking section comprising a spiral blade at a front part of the threshing drum; and
a fixed debris transport valve with a fixed feed angle above the raking section.

11. The threshing apparatus according to claim 6,
wherein a receiving net is provided extending along an outer periphery of the threshing drum, below the threshing drum, and
wherein an interval in a radial direction between a movement path of a radial outer end of the threshing drum and a radial inner end of the debris transport valve is greater than an interval in a radial direction between the movement path of the radial outer end of the threshing drum and a radial inner end of the receiving net.

12. A harvester comprising:
a harvesting section configured to harvest a crop in a field; and
a threshing apparatus into which the crop harvested by the harvesting section is introduced and which is configured to thresh the introduced crop,
wherein the threshing apparatus comprises:
a threshing chamber into which the crop is introduced;
a threshing drum provided in the threshing chamber so as to rotate with a threshing drum axis extending in a front-rear direction of the threshing chamber serving as a rotation center, and configured to thresh the crop introduced into the threshing chamber; and
a receiving net provided in an outer periphery of a lower part of the threshing drum,
wherein the receiving net is divided into a plurality of divided receiving net bodies in a peripheral direction of the threshing drum,
each of the plurality of divided receiving net bodies includes a support shaft provided extending in the front-rear direction on one end in the peripheral direction of the divided receiving net body, and is supported in such a manner as to be capable of swinging vertically with the support shaft serving as a swinging support point,
wherein the harvester further comprises a single actuator linked to the plurality of divided receiving net bodies via a link mechanism, and
wherein the link mechanism swings the plurality of divided receiving net bodies vertically due to being operated by the actuator, and adjusts an interval in a radial direction of the threshing drum between the divided receiving net body and the threshing drum in the plurality of divided receiving net bodies.

13. The harvester according to claim 12,
wherein the support shaft of the divided receiving net body is provided on an end located downstream in a threshing material movement direction in the divided receiving net body, out of both ends in the peripheral direction of the divided receiving net body.

14. The harvester according to claim 13,
wherein the link mechanism is joined to an end opposite to where the support shaft is located in each of the plurality of divided receiving net bodies.

15. The harvester according to claim 12,
wherein the link mechanism comprises:
a parallel link that is moved in parallel by the actuator; and
a swinging link that has a free end engaged with the parallel link and performs output to the divided receiving net body by being swung by the parallel link,
wherein the parallel link and the free end are engaged by an elongated groove provided in one of the parallel link and the free end, and a linking member supported by the other of the parallel link and the free end while being slidably inserted in the elongated groove, and
wherein the linking member is rotatably supported by the other of the parallel link and the free end while being formed in a non-circular shape so as to be non-rotatably inserted in the elongated groove.

16. A threshing apparatus comprising:
a threshing chamber into which a reaped grain culm is introduced;
a threshing drum rotatably provided in the threshing chamber;
a receiving net provided along an outer periphery of the threshing drum, below the threshing drum; and
a sorting apparatus located below the receiving net and receives and sorts threshing material leaked from the receiving net while swinging and transferring the threshing material,
wherein an upstream end of the receiving net located on an upstream side in a rotation direction of the threshing drum is located at a position lower than a rotation axis of the threshing drum, and a side wall portion is included at the upstream side in the rotation direction of the threshing chamber relative to the upstream end of the receiving net, and
wherein a downstream end of the receiving net located on a downstream side in the rotation direction of the threshing drum is located at a position higher than the rotation axis of the threshing drum.

17. The threshing apparatus according to claim 16,
wherein in a view in a rotation axis direction of the threshing drum, the sorting section is arranged toward one side in a left-right direction with respect to the threshing drum.

18. The threshing apparatus according to claim 17,
wherein the sorting apparatus is arranged biased such that a center position in the left-right direction of the sorting apparatus is a position biased toward the downstream end of the receiving net with respect to the rotation axis of the threshing drum.

19. The threshing apparatus according to claim 16,
whereing the upstream end of the receiving net is located inward in the left-right direction with respect to a movement path outer end position that is located on an outermost side in the left-right direction of a movement path of a radial outer end of the threshing drum and is close to the upstream end.
